(19) United States
(12) Patent Application Publication
(10) Pub. No.: US 2016/0021663 A1
(43) Pub. Date: Jan. 21, 2016

(54) WIRELESS COMMUNICATION DEVICE AND WIRELESS COMMUNICATION METHOD

(71) Applicants: SHARP KABUSHIKI KAISHA, Osaka-shi, Osaka (JP); OSAKA UNIVERSITY, Suita-shi, Osaka (JP)

(72) Inventors: Hiroki TAKAHASHI, Osaka-shi, Osaka (JP); Jungo GOTO, Osaka-shi, Osaka (JP); Osamu NAKAMURA, Osaka-shi, Osaka (JP); Kazunari YOKOMAKURA, Osaka-shi, Osaka (JP); Yasuhiro HAMAGUCHI, Osaka-shi, Osaka (JP); Seiichi SAMPEI, Suita-shi, Osaka (JP); Shinichi MIYAMOTO, Suita-shi, Osaka (JP); Shinsuke IBI, Suita-shi, Osaka (JP)

(73) Assignees: OSAKA UNIVERSITY, Suita-shi, Osaka (JP); SHARP KABUSHIKI KAISHA, Osaka-shi, Osaka (JP)

(21) Appl. No.: 14/772,024

(22) PCT Filed: Mar. 4, 2014
(86) PCT No.: PCT/JP2014/055419

§ 371 Date: Sep. 1, 2015

(30) Foreign Application Priority Data
Mar. 4, 2013 (JP) 2013-042340

(51) Int. Cl. H04W 72/04; H04L 1/00

(52) U.S. Cl. CPC H04W 72/0453; H04L 1/0071; H04L 1/0041; H04W 84/042

(57) ABSTRACT

According to one aspect of the present invention, there is provided a wireless communication device that transmits a first wireless signal representing a bit sequence to a reception device, in which the first wireless signal is transmitted concurrently with a second wireless signal representing the bit sequence described above, and in which between the first wireless signal and the second wireless signal, components with a prescribed ratio are mapped to a different frequency or to a different time between the first wireless signal and the second wireless signal and remaining components are mapped to the same frequency and to the same time between the first wireless signal and the second wireless signal.

### TECHNICAL FIELD

The present invention relates to a wireless communication device and a wireless communication method.

This application claims the benefit of Japanese Priority Patent Application 2013-042340 filed on Mar. 4, 2013, the entire contents of which are incorporated herein by reference.

### BACKGROUND ART

In a cellular system, there is present a problem in which a terminal device that is positioned in the neighborhood of a boundary (a cell edge) of an area that is covered by a base station device generally is prone to interference from a neighboring cell and thus satisfactory transfer performance is not obtained. A transmission diversity technology in which multiple transmit antennas are used, a coordinated multi-point transmission and reception (CoMP) technology in which cooperation is performed among multiple base stations or transmission points and data that is destined for the same device is transmitted, and the like are effective in addressing this problem.

For example, in connection with the transmission diversity technology, a beam forming technique has been studied in great depth in which a channel state between the terminal device and the base station device is measured, a result of the measurement is fed back by the terminal device, and then precoding that makes reception performance satisfactory is performed on the same signal that is transmitted from multiple transmit antennas on the base station device side. The beam forming is a technology that is receiving attention, because the reception performance can be improved with the beam forming and an interference problem in the cell edge can be overcome by applying the beam forming to the CoMP.

However, there is a need to estimate in advance with precision channel performance that is used for transfer, in order to form this beam, and a large amount of channel state information has to be fed back from the terminal device to the base station device. Moreover, for the CoMP, there is a need for high-precision frequency synchronization between base station devices that cooperate with each other. For this reason, in a case where an error is included in these, there occurs a problem that performance degrades remarkably.

Orthogonal space time block code (OSTBC) is an effective technique in that a diversity effect is obtained without the feedback being required, but in a case where the number of transmit antennas is greater than 2, there occurs a problem that a transfer rate has to be lowered in order to form an orthogonal code in space.

To address the multiple problems described above, in PTL 1, the inventors disclose a reception device, a transmission device, a reception method, a transmission method, and a program that realize an improved diversity effect without the channel state information for the precoding and without lowering the transfer rate. In PTL 1, the transmission device applies interleave that is different from one transmit antenna to another with respect to the same data, and thus generates a signal sequence that is independent among the antennas. In the reception device, a bit log likelihood ratio (LLR) of each demultiplexed signal sequence is de-interleaved and is combined as the LLR of the same data. Thus, reliability of decoded bits is improved. Moreover, it is possible to generate a replica of each signal sequence from the combined LLR, to suppress interference between layers with repetitious decoding in which processing that feeds back the generated replica as prior information to reception processing is repeated, and to acquire an improved transmission diversity effect.

### CITATION LIST

### Patent Document

[Patent Document 1] Japanese Unexamined Patent Application Publication No. 2011-040680

### DISCLOSURE OF THE INVENTION

### Problems to be Solved by the Invention

However, in the reception processing in PTL 1, there is a need to perform demultiplexing on every signal sequence prior to the combination, and in a case where a result of decoding each signal sequence is not satisfactory, an effect of improvement by the repetitious decoding is not sufficiently obtained. As a result, there is a problem that a sufficient transmission diversity effect is not obtained.

The present invention, which is made in view of this situation, is to provide a wireless communication device and a wireless communication method that are capable of performing transfer with high frequency utilization efficiency.

### Means for Solving the Problems

(1) According to an aspect of the present invention, which is made to solve the problems described above, there is provided a wireless communication device that transmits a first wireless signal representing a bit sequence to a reception device, in which the first wireless signal is transmitted concurrently with a second wireless signal representing the bit sequence, and in which, between the first wireless signal and the second wireless signal, components with a prescribed ratio are mapped to an identical frequency and to an identical time between the first wireless signal and the second wireless signal and remaining components are mapped to a different frequency or a different time between the first wireless signal and the second wireless signal.

(2) Furthermore, according to another aspect of the present invention, the wireless communication device according to (1), may further include an interleave module that, in the bit sequence, performs first interleave on bits with a prescribed ratio, and performs second interleave on remaining bits, and a transmission module that generates the first wireless signal from a bit sequence that is output by the interleave module, and transmits the generated first wireless signal, in which the second wireless signal may be a wireless signal that is generated from a bit sequence resulted from performing third interleave different from the first interleave on the bits with the prescribed ratio and from a bit sequence resulted from performing the second interleave on the remaining bits.

(3) Furthermore, according to another aspect of the present invention, the wireless communication device according to (1), may further include a DFT module that implements DFT processing on multiple modulation symbols that are based on the bit sequence and generates multiple single carrier symbols, a cyclic shift module that, among the multiple single carrier symbols, performs first cyclic shift that is a shift amount which is 0 or greater in a frequency domain, on single carrier symbols with a prescribed ratio, and performs second cyclic shift that is a shift amount which is 0 or greater in a frequency domain, on remaining single carrier symbols, and a transmission module that generates the first wireless signal from single carrier symbols that are output by the cyclic shift module and outputs the generated first wireless signal, in which the second wireless signal may be a wireless signal that is generated after, among the multiple single carrier symbols, third cyclic shift that is a shift amount which is different from that of the first cyclic shift, is performed on the single carrier symbols with the prescribed ratio and the second cyclic shift is performed on the remaining single carrier symbols.

(4) According to another aspect of the present invention, in the wireless communication device according to any one of (1) to (3), the wireless communication device may generate and transmit the second wireless signal.

(5) Furthermore, according to another aspect of the present invention, in the wireless communication device according to any one of (1) to (3), which transmits the bit sequence to one reception device by cooperating with a different wireless communication device, the second wireless signal may be generated and be transmitted by the different wireless communication device.

(6) Furthermore, according to another aspect of the present invention, in the wireless communication device according to any one of (1) to (5), information indicating the prescribed ratio may be notified by the reception device.

(7) Furthermore, according to another aspect of the present invention, the wireless communication device according to any one of (1) to (5) may further include a ratio determination module that determines the prescribed ratio in such a manner that the reception device is able to demultiplex the first wireless signal and the second wireless signal.

(8) Furthermore, according to another aspect of the present invention, there is provided a wireless communication device that receives a signal resulted from spatially multiplexing a first wireless signal and a second wireless signal that represent an identical bit sequence, the wireless communication device including a ratio determination module that determines a prescribed ratio in such a manner that the first wireless signal and the second wireless signal are able to be demultiplexed and a ratio notification module that notifies a transmission source of the first wireless signal or the second wireless signal of a ratio that is determined by the ratio determination module, in which, between the first wireless signal and the second wireless signal, components with a prescribed ratio are mapped to a different frequency or to a different time between the first wireless signal and the second wireless signal, and remaining components are mapped to an identical frequency and to an identical time between the first wireless signal and the second wireless signal.

(9) Furthermore, according to another aspect of the present invention, the wireless communication device according to (8) may further include a ratio determination module that determines the prescribed ratio in such a manner that the first wireless signal and the second wireless signal are able to be demultiplexed, and a ratio notification module that notifies the transmission source of the first wireless signal or the second wireless signal of the ratio that is determined by the ratio determination module.

(10) Furthermore, according to another aspect of the present invention, there is provided a wireless communication method including a process of generating a first wireless signal representing a bit sequence, and a process of transmitting the first wireless signal to a reception device, in which the first wireless signal is transmitted concurrently with a second wireless signal representing the bit sequence, and in which between the first wireless signal and the second wireless signal, components with a prescribed ratio are mapped to a different frequency or to a different time between the first wireless signal and the second wireless signal, and remaining components are mapped to an identical frequency and to an identical time between the first wireless signal and the second wireless signal.

(11) Furthermore, according to another aspect of the present invention, there is provided a wireless communication method including a process of receiving a signal resulted from spatially multiplexing a first wireless signal and a second wireless signal that represent an identical bit sequence, and a process of demultiplexing the received signal into a component of the first wireless signal and a component of the second wireless signal, in which the first wireless signal is transmitted concurrently with the second wireless signal representing the bit sequence, and in which, between the first wireless signal and the second wireless signal, components with a prescribed ratio are mapped to a different frequency or to a different time between the first wireless signal and the second wireless signal, and remaining components are mapped to an identical frequency and to an identical time between the first wireless signal and the second wireless signal.

### Effects of the Invention

According to one aspect of the invention, transfer with high frequency utilization efficiency can be performed.

### BRIEF DESCRIPTION OF THE DRAWINGS

FIG. 1 is a schematic diagram illustrating a configuration of a wireless communication system 10 according to a first embodiment of the present invention.

FIG. 2 is a schematic block diagram illustrating a configuration of a base station device 100 according to the same embodiment.

FIG. 3 is a schematic block diagram illustrating an internal configuration of an OFDM signal generation module 107-m (m=1, 2, and so forth up to M) according to the same embodiment.

FIG. 4 is a schematic block diagram illustrating a configuration of a terminal device 200 according to the same embodiment.

FIG. 5 is a schematic block diagram illustrating an internal configuration of an OFDM signal reception processing module 202-n (n=1, 2, and so forth up to N) according to the same embodiment.

FIG. 6 is a schematic block diagram illustrating a configuration of a repetition processing module 207 according to the same embodiment.

FIG. 7 is a schematic diagram illustrating a configuration of a wireless communication system 20 according to a second embodiment of the present invention.

FIG. 8 is a schematic block diagram illustrating configurations of base station devices 300-1 and 300-2 according to the same embodiment.

FIG. 9 is a schematic diagram illustrating a configuration of a wireless communication system 10a according to a third embodiment of the present invention.

FIG. 10 is a schematic block diagram illustrating a configuration of a terminal device 100a that is a transmission device according to the same embodiment.

FIG. 11 is a schematic block diagram illustrating an internal configuration of a DFT-S-OFDM signal generation module 501-m (m=1, 2, and so forth up to M) according to the same embodiment.

FIG. 12 is a schematic block diagram illustrating an internal configuration of a layer processing module 600-m according to the same embodiment.

FIG. 13 is a schematic block diagram illustrating a configuration of a terminal device 100b according to a fourth embodiment of the invention.

FIG. 14 is a diagram illustrating one example of an amount of cyclic shift according to the same embodiment.

FIG. 15 is a schematic block diagram illustrating a configuration of a repetition processing module 207b according to the same embodiment.

FIG. 16 is a diagram illustrating a comparison of signals that are transmitted from transmit antennas, respectively, according to the same embodiment.

FIG. 17 is a diagram illustrating one example of an EXIT chart.

### MODE FOR CARRYING OUT THE INVENTION

### First Embodiment

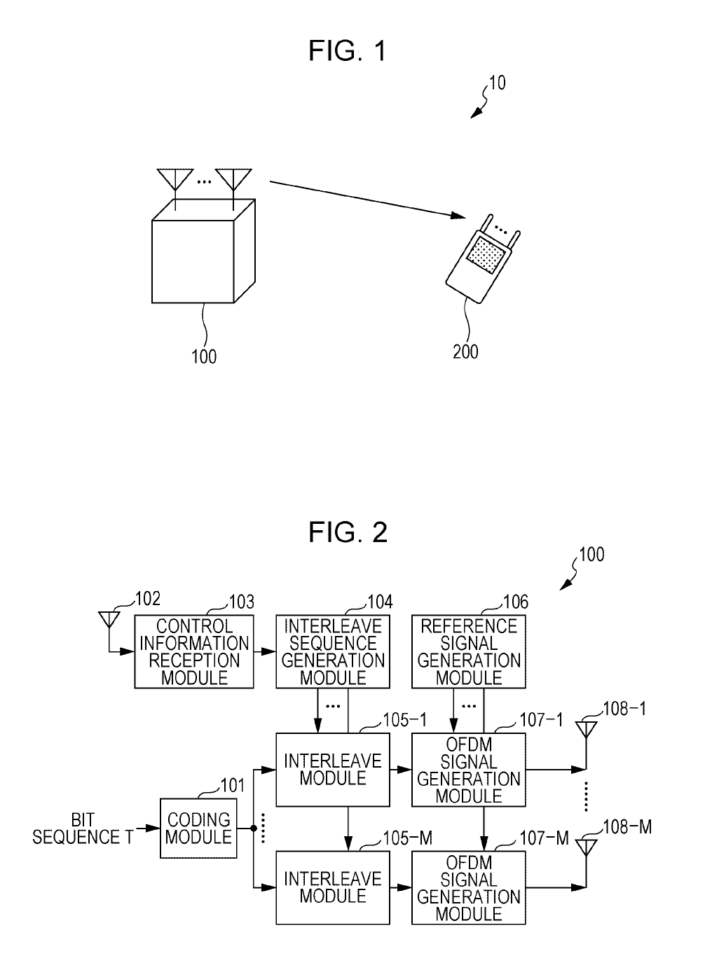

A first embodiment of the present invention will be described referring to the drawings. FIG. 1 is a schematic diagram illustrating a configuration of a wireless communication system 10 according to the present embodiment. As illustrated in FIG. 1, the wireless communication system 10 is configured to include a base station device 100 that has M transmit antennas and a terminal device 200 that has N receive antennas.

FIG. 2 is a schematic block diagram illustrating a configuration of the base station device 100 according to the present embodiment. However, a block diagram of only a portion relating to downlink for data transmission from the base station device 100 to the terminal device 200 is provided, a portion that performs data reception for uplink, and the like are omitted.

The base station device 100 is configured to include a coding module 101, a receive antenna 102, a control information reception module 103, an interleave sequence generation module 104, M interleave modules 105-1 to 105-M, a reference signal generation module 106, M OFDM signal generation modules 107-1 to 107-M and M transmit antennas 108-1 to 108-M. Modules that are assigned branch numbers, such as the interleave modules 105-1 to 105-M and the OFDM signal generation modules 107-1 to 107-M, process layer signals in layers that correspond to the branch numbers, respectively and the transmit antennas 108-1 to 108-M transmit the signals in the layers that correspond to the branch numbers, respectively.

In the base station device 100, a bit sequence T that is information bits to transmit is input into the coding module 101. The coding module 101 performs error correction coding, such as turbo coding, convolutional coding, or low density parity check (LDPC) coding, on the bit sequence T. A bit sequence (a coded bit sequence) that results from the error correction coding is input into the interleave modules 105-1 to 105-M, which are such that the same sequence corresponds to each layer. However, a configuration may be employed in which a copy module that copies the coded bit sequence according to the number of layers is included and the coded bit sequence that is copied by the copy module is input into each of the interleave modules. According to the present embodiment, the number of transmit antennas is assumed to be M, and the coded bit sequence that is used for generation of a signal to transmit is the same as in the transmit antennas 108-1 to 108-M. Furthermore, the number of copies of the same coded bit sequence that are made according to the number of transmit antennas is hereinafter referred to as the “number of layers,” and signals that are transmitted from the transmit antennas 108-1 to 108-M are defined as signals in first to M-th layers, respectively.

The control information reception module 103 receives control information that is destined for the base station device 100 and that is transmitted from the terminal device 200, through the receive antenna 102. A control parameter ρ in an interleave sequence (but, 0≦ρ≦1) is included in the control information, and the control information reception module 103 inputs the control parameter ρ into the interleave sequence generation module 104. However, other pieces of information that are notified by the terminal device 200 may be included in the control information.

Furthermore, the value ρ may be determined based on a different piece of information that is received as the control information. For example, ρ may be calculated based on channel state information (CSI) that is included in the control information.

The interleave sequence generation module 104 generates interleave sequences Π₁ to Πₘ that are used in the interleave module 105-1 to 105-M, according to a transmission parameter for a sequence length of a coded bit (that is output from the coding module 101) that is input into the interleave modules 105-1 to 105-M, an identification number that specifies a terminal device, or the like, and the control parameter ρ that is input from the control information reception module 103. However. ρ indicates a ratio of coded bits that are rearranged in different positions between layers to the coded bits that are input into each of the interleave modules 105-1 to 105-M.

At this point, when the sequence length of the coded bit is assumed to be N_{c}, Πₘ (m=1, 2, and so forth up to M) can be indicated with an N_{c}×N_{c} matrix, and Πₘ is a matrix that includes one 1 in each row and each column and in which the other elements are assumed to be 0s. That is, in a case where Πₘ=[π_{m,1}, π_{m,2}, . . . , π_{m,q}, . . . , π_{m,Nc}]^{T} is established, when in a m-th layer, a post-interleave q-th bit is a pre-interleave i-th bit, π_{m,q} is a vector in a (N_{c}×1)-th row, in which the i-th element is 1 and the other elements are 0s. However, [ ]^{T} is a transposed matrix.

Accordingly, for example, if π_{1,q}=π_{2,q} is given, this indicates that the q-th bit that is output from the interleave module 105-1, and the q-th bit that is output from the interleave module 105-2 are the same.

At this point, the interleave sequence generation module 104 controls a ratio of q that attains π_{1,q}≠ . . . ≠π_{m,q}≠ . . . ≠π_{M,q}, among the interleave sequences Π₁ to Πₘ, in such a manner that a ratio that is indicated with the control parameter ρ that is input by the control information reception module 103 is not exceeded. ρ takes a value ranging from 0 to 1. ρ is a ratio that attains π_{1,q}≠ . . . ≠π_{m,q}≠ . . . ≠π_{M,q} between first to M-th layers, and is a ratio at which (1−ρ) is π_{1,q}≠ . . . ≠π_{m,q}≠ . . . ≠π_{M,q} between the first to M-th layers. Therefore, in a case where ρ=0, the bit sequences that are output from the interleave modules 105-1 to 105-M are the same sequences that result from the same interleave. In a case where ρ=1, the bit sequences that are output from the interleave modules 105-1 to 105-M are sequences that are different from each other.

In a case where 0<ρ<1, a rule for which row in a matrix Πₘ a vector that is set to be the same as a different layer is positioned in may be arbitrarily prescribed in the system. For example, first to (1−ρ) N_{c}-th numbers may be set to be the same in the number N_{c} of rows. Among Nₛ modulation symbols that are generated from N_{c} coded bits in a modulation module 111-m, rows that correspond to the coded bits that are equivalent to first to (1−ρ) Nₛ-th symbols may be the same. Furthermore, in a case where (1−ρ) N_{c} or (1−ρ) Nₛ is not an integer, the smallest integer that is equal to or greater than (1−ρ) N_{c} or is equal to or greater than (1−ρ) Nₛ may be prescribed using a ceiling function. However, the rule is known to the terminal device 200 that is a reception device.

Furthermore, according to the present embodiment, an arbitrary value that satisfies 0≦ρ≦1 is given, but it is possible to limit a value that can take ρ. For example, values that are selectable may be nine types in increments of 0.125, satisfying 0≦ρ1. A range that can be set may be limited to 0≦ρ≦0.5. With these types of control, it is possible to reduce an amount of control information for notifying ρ. Moreover, instead of ρ, the number q of bits that use the same interleave sequence may be notified as a value indicating ρ.

Moreover, the interleave sequence generation module 110 may generate the interleave sequence at every transmission opportunity, and information that indicates the generated interleave sequence may be notified to the terminal device 200, along with data (the bit sequence T).

In the interleave modules 105-1 to 105-M, rearrangement of a bit sequence of coded bits is performed in accordance with the interleave sequence that is notified from the interleave sequence generation module 104 to each of the interleave modules 105-1 to 105-M. For example, in a case where the coded bit sequence that is input by the coding module 101 is expressed with c=[c₁, c₂, and so forth up to c_{Nc}]^{T}, the processing in the interleave module 105-m can be realized by Equation (1) that follows, using Πₘ that is input by the interleave sequence generation module 104. However, c′ₘ in Equation (1) is a vector that indicates the post-interleave bit sequence that is output by the interleave module 105-m.

[Math. 1]

c′ₘ=Πₘc (1)

Moreover, according to the present embodiment, interleave processing in the interleave sequence generation module 104 and the interleave modules 105-1 to 105-M is indicated by a matrix operation, but the same processing may be realized by an arbitrary circuit.

The reference signal generation module 106 generates a reference signal (a pilot signal) that corresponds to each of layers 1 to M and that is known to the terminal device 200 which is a transmission destination, and inputs the generated reference signal to each of the OFDM signal generation modules 107-1 to 107-M. At this point, as the reference signal for downlink, that is, as the reference signal that is generated in the reference signal generation module 106, there are a reference signal that is used for determining a band which is used for transfer, and a reference signal that is used for demodulation. For example, in LTE or LTE-A, there are reference signals that are referred to as a common-reference signal (RS), a cell specific RS (CRS), a channel state information (CSI) RS, and a de-modulation (DM) RS.

The OFDM signal generation modules 107-1 to 107-M generate an OFDM signal using the coded bit that is input from each of the interleave modules 105-1 to 105-M, and a reference signal in each layer that is input from the reference signal generation module 106, and transmit the generated signal to the terminal device 200 through the transmit antennas 108-1 to 108-M.

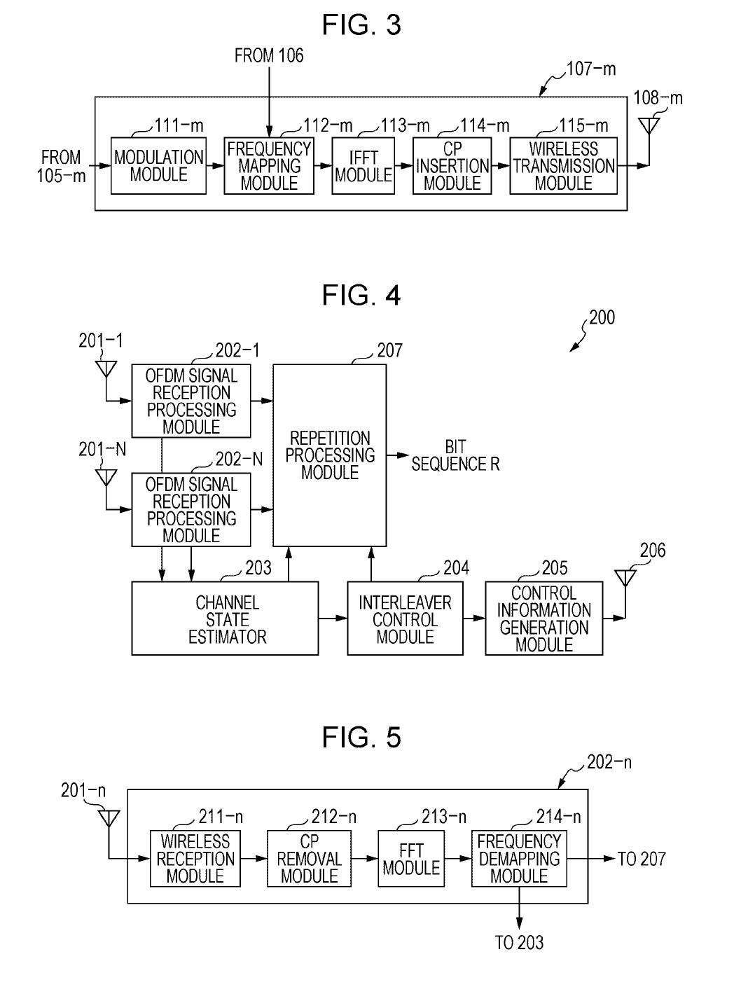

However, because the OFDM signal generation modules 107-1 to 107-M perform the same processing, an internal configuration of the OFDM signal generation module 107-m (m=1, 2, and so forth up to M) is representatively illustrated in FIG. 3. The OFDM signal generation module 107-m is configured to include the modulation module 111-m, a frequency mapping module 112-m, an IFFT module 113-m, a CP insertion module 114-m, and a wireless transmission module 115-m.

The coded bit sequence that results from the interleave module 105-m changing a sequence in which bits are arranged is input into the modulation module 111-m. The modulation module 111-m performs modulation such as quaternary phase shift keying (QPSK) and 16-ary quadrature amplitude modulation (16 QAM), and inputs a result of the modulation to the frequency mapping module 112-m.

A modulation signal that is modulated by the modulation module 111-m, and the reference signal that is generated by the reference signal generation module 106 are input into the frequency mapping module 112-m. The frequency mapping module 112-m assigns the modulation signal and the reference signal that are input, to a frequency band (a subcarrier) that is used for transfer, and generates a frequency signal group.

The IFFT module 113-m converts the frequency signal group that is generated in the frequency mapping module 112-m, into a signal in a time domain, using inverse fast Fourier transform (IFFT).

The CP insertion module 114-m inserts a cyclic prefix (CP) into the signal in the time domain, which is generated by the IFFT module 113-m.

The wireless transmission module 115-m converts the signal into which the CP is inserted by the CP insertion module 114-m, into an analog signal with digital/analog (D/A) conversion, and then up-converts a result of the conversion into a wireless frequency that is used for transfer. Moreover, the wireless transmission module 115-m performs processing, such as amplifying transmission power with a power amplifier (PA), on the signal that results from the up-converting, and outputs the resulting signal into the transmit antenna 108-m.

As described above, because the interleave sequence that is generated by the interleave sequence generation module 104 is different between layers, the frequency signal groups in each layer, which are generated in the OFDM signal generation modules 107-1 to 107-M, are frequency signal groups that are different between the layers. Moreover, according to the present embodiment, the number of layers and the number of transmit antennas are described as being consistent with each other, and the signal in each layer is described as being transmitted with each transmit antenna. However, if the number of transmit antennas is the same as or greater than the number of layers, this may be sufficient. Transmission may be performed by multiplying the frequency signal group, which is generated by each of the frequency mapping modules 112-1 to 112-m, by a precoding matrix with the number of transmit antennas×the number of layers.

However, according to the present embodiment, the interleave modules 105-1 to 105-M in FIG. 2 are arranged in such a manner that they are input from the coding module 101, but may be arranged after the modulation module 111-m (m=1, 2, and so forth up to M) within the OFDM signal generation module 107-m that is illustrated in FIG. 3. Accordingly, interleave can be performed in modules of modulation symbols.

Furthermore, in the interleave modules 105-1 to 105-M that are illustrated in FIG. 2, a configuration may be employed in which bit interleave that is different between the layers is performed only on a ρN_{c} bit that is set with ρ, a second interleave module is arranged after the modulation module 111-m within the OFDM signal generation module 107-m that is illustrated in FIG. 3, and symbol interleave that is the same between the layers is performed on all symbol sequences that are output by the modulation module 111-m. With this configuration, because the interleave is performed on all of the symbol sequences while, among all the symbol sequences, the modulation symbol at a ratio of (1−ρ) is transmitted at the same point in time over the same frequency between the layers, satisfactory performance is obtained.

FIG. 4 is a schematic block diagram illustrating a configuration of the terminal device 200 according to the present embodiment. The terminal device 200 is configured to include N receive antennas 201-1 to 201-N, N OFDM signal reception processing modules 202-1 to 202-N, a channel state estimator 203, an interleave control module 204, a control information generation module 205, a transmit antenna 206, and a repetition processing module 207.

In the terminal device 200 in FIG. 4, a signal that is transmitted from the base station device 100 is received using the receive antennas 201-1 to 201-N. The number M of transmit antennas of the base station device 100 and the number N of receive antennas of the terminal device 200 may be different from each other, and may be the same. Furthermore, the number N of receive antennas of the terminal device 200 may be equal to or greater than 2. The signals that are received from each of the receive antenna 201-1 to 201-N are input into the OFDM signal reception processing modules 202-1 to 202-N, respectively and reception processing is performed in each of the OFDM signal reception processing modules 202-1 to 202-N, but because processing in the OFDM signal reception processing modules 202-1 to 202-N is the same, at this point, an internal configuration of the OFDM signal reception processing module 202-n (n=1, 2, and so forth up to N) is representatively illustrated in FIG. 5.

The OFDM signal reception processing module 202-n is configured to include a wireless reception module 211-n, a CP removal module 212-n, an FFT module 213-n, and a frequency demapping module 214-n.

The wireless reception module 211-n down-converts the signal that is received by the receive antenna 201-n into a baseband frequency, converts a result of the down-converting into a digital signal with analog-to-digital (A/D) conversion, and then outputs the resulting signal to the CP removal module 212-n.

The CP removal module 212-n removes the CP from the digital signal that is input, and outputs the resulting signal to the FFT module 213-n.

The FFT module 213-n performs Fast Fourier Transform on the signal from which the CP is removed, and thus converts the signal in a time domain into the signal in a frequency domain and outputs a result of the converting to the frequency demapping module 214-n.

The frequency demapping module 214-n extracts each of the data signal and the reference signal that are time- and frequency-multiplexed, from the signal in the frequency domain that is input from the FFT module 213-n, and outputs the data signal and the reference signal to the repetition processing module 207 and the channel state estimator 203, respectively.

Referring back to FIG. 4, the reference signal that is extracted in the OFDM signal reception processing modules 202-1 to 202-N (frequency demapping modules 214-1 to 214-N in FIG. 5) is input into the channel state estimator 203. Based on the reference signal that is input, the channel state estimator 203 estimates a frequency response of a channel for each of the combinations of the transmit antennas 108-1 to 108-M of the base station device 100 and the receive antennas 201-1 to 201-N of the terminal device 200. An estimated value of the obtained frequency response is output to the interleave control module 204 and the repetition processing module 207.

The repetition processing module 207 restores the bit sequence that is transmitted by the base station device 100, from the data signal that is extracted in the OFDM signal reception processing modules 202-1 to 202-N (the frequency demapping modules 214-1 to 214-N in FIG. 5), using the frequency response of the channel, which is estimated in the channel state estimator 203, and outputs a result of the restoration as the bit sequence. In the repetition processing module 207, when restoring the bit sequence, turbo equalization that repeats interference removal and decoding of error-corrected code is applied.

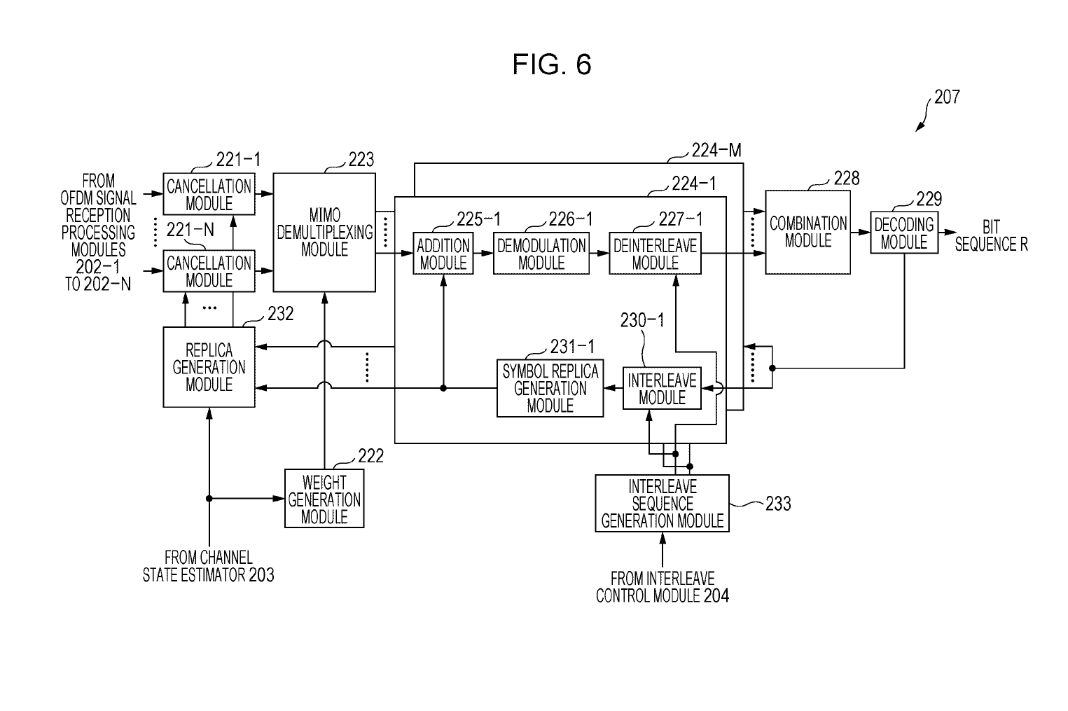

FIG. 6 is a schematic block diagram illustrating a configuration of the repetition processing module 207. The repetition processing module 207 is configured to include N cancellation modules 221-1 to 221-N, a weight generation module 222, a multi-input multi-output (MIMO) demultiplexing module 223, M layer processing modules 2248-1 to 224-M, a combination module 228, a decoding module 229, a replica generation module 232, and an interleave sequence generation module 233. The layer processing modules 224-1 to 224-M perform processing of pieces of data that correspond to branch numbers of the transmit antennas 108-1 to 108-M, respectively. Each of the layer processing modules 224-1 to 224-M is configured to include an addition module 225, a demodulation module 226, a deinterleave module 227, an interleave module 230, and a symbol replica generation module 231. Moreover, the addition module 225, the demodulation module 226, the deinterleave module 227, the interleave module 230, and the symbol replica generation module 231 are hereinafter assigned the same branch number as those of the layer processing modules to which they belong, respectively, and the demodulation module 226 of the layer processing module 224-1 is expressed as is the case with the demodulation module 226-1.

Pieces of the data signal that are output by the OFDM signal reception processing modules 202-1 to 202-N to the repetition processing module 207 are input into the corresponding cancellation modules 221-1 to 221-N. That is, the data signal that is output by the OFDM signal reception processing module 202-1 is input into the cancellation module 221-1, and the data signal that is output in the OFDM signal reception processing module 202-2 is input into the cancellation module 221-2. Furthermore, the frequency response of each channel, which is estimated by the channel state estimator 203, is input into the replica generation module 232 and the weight generation module 222.

The cancellation module 221-1 subtracts a replica of a receive signal of the receive antenna 201-1, which is input by the replica generation module 232, from the data signal that is input from the OFDM signal reception processing module 202-1, and outputs the signal that remains after the subtraction to the MIMO demultiplexing module 223. In the same manner, each of the cancellation modules 221-2 to 221-N subtracts the replica of the receive signal of the corresponding receive antenna, which is input by the replica generation module 232, from the data signal that is input from the corresponding one among the OFDM signal reception processing modules 202-2 to 207-N, and outputs the signal that remains after the subtraction to the MIMO demultiplexing module 223. However, in the cancellation modules 221-1 to 221-N, when repetitious processing is performed for the first time without an output of the decoding module 229, nothing is done and the data signal that is input, as is, is output to the MIMO demultiplexing module 223.

An estimated value Hₘₙ of the frequency response between the transmit antenna 108-m and the receive antenna 201-n is input into the weight generation module 222, which generates weight for demultiplexing the signals that are received from the receive antennas into the signals according to the transmit antenna. However, with an index of the transmit antenna, m satisfies 1≦m≦M, and with an index of the receive antenna, n satisfies 1≦n≦N. Furthermore, the weight that is generated is minimum mean square error weight (MMSE), zero forcing weight (ZF), or the like. The generated weight is input into the MIMO demultiplexing module 223.

The MIMO demultiplexing module 223 multiplies the remaining signals that are output by the cancellation modules 221-1 to 221-N by the weight that is input by the weight generation module 222, and thus MIMO-demultiplexes the signals into the signals in the layers that correspond to the transmit antennas 108-1 to 108-M, respectively. The MIMO demultiplexing module 223 outputs the MIMO-demultiplexed signal to a block that processes the corresponding layer, among the layer processing modules 224-1 to 224-M. For example, the MIMO-demultiplexed signal from the transmit antenna 108-1 is output into the addition module 225-1 of the layer processing module 224-1, and the signal from the transmit antenna 108-2 is output to the addition module 225-2 of the layer processing module 224-2.

The addition module 225-1 adds a symbol replica that is generated by the symbol replica generation module 231-1 that will be described below to the signal that is input from the MIMO demultiplexing module 223, and outputs a result of the operation to the demodulation module 226-1. In the same manner, the addition modules 225-2 to 225-M also add a symbol replica corresponding to each of the signals that are input from the MIMO demultiplexing module 224. Each of the demodulation modules 226-1 to 226-M performs demodulation corresponding to a modulation scheme that is employed in the base station device 100, on the signals that are input from the corresponding addition modules 225-1 to 225-M, and converts the resulting signal into a bit logarithm likelihood ratio (LLR) for the coded bit sequence. In each of the demodulation module 226-1 to 226-M, the bit LLR is output to a block that processes the corresponding layer, among the deinterleave modules 227-1 to 227-M. For example, the demodulation module 226-1 performs outputting to the deinterleave module 227-1, and the demodulation module 226-2 performs outputting to the deinterleave module 227-2.

The deinterleave modules 227-1 to 227-M perform the bit LLR that is input, and perform rearrangement that is the reverse of the interleave that is designated from the interleave sequence generation module 233. That is, the deinterleave modules 227-1 to 227-M perform the rearrangement that is the reverse of the interleave that is performed in the corresponding interleave module 105, on the bit LLR that is input, among the interleave modules 105-1 to 105-M of the base station device 100. For example, in the deinterleave module 227-1, the rearrangement is performed that returns the rearrangement by the interleave module 105-1 to its original state, and in the deinterleave module 227-2, the rearrangement is performed that returns the rearrangement by the interleave module 105-2 to its original state. As is described above, in a case where the interleave sequence that is used in the interleave module 105-m which corresponds to an m-th layer is expressed with Πₘ, an N_{c}×N_{c} deinterleave sequence Φₘ that is used in the deinterleave module 227-m is a transposed matrix of the interleave sequence Πₘ as in Equation (2).

[Math. 2]

Φₘ=Πₘ^{T} (2)

Therefore, when an LLR that is input into the deinterleave module 227-m is set to be an N_{c}×1 vector λ′ₘ, post-deinterleave LLR λₘ is expressed with Equation that follows.

[Math. 3]

λₘ=Φₘλ′ₘ (3)

At this point, a k-th bit LLR that is output from the deinterleave module 227-m is expressed as λₘ(k). However, λₘ(k) is a bit LLR for the coded bit that corresponds to a pre-interleave k-th bit in the m-th transmit antenna 108-m. In the deinterleave module 227-m, λₘ(k) is output to the combination module 228.

λ₁(k), λ₂(k), and so forth up to λ_{M}(k), which are the bit LLRs for the transmit antennas 108-1 to 108-M, respectively are input into the combination module 228, but the coded bit that is transmitted by each of the transmit antennas 108-1 to 108-M corresponds to the coded bit that is an output of the coding module 101 of the base station device 100, and the bit sequence from which the coded bit is originated is the same.

For this reason, it is possible to combine these bit LLRs. According to Equation (4) that follows, the combination module 228 combines these bit LLRs, and λ^{A}(k) that is a post-combination bit LLR is calculated.

$$\begin{matrix}[ Math . 4 ] & \\ {λ}^{A} ( k ) = {\sum }_{m = 1}^{M} {λ}_{m} ( k ) & ( 4 )\end{matrix}$$

However, according to the present embodiment, a combination method that is expressed in Equation (4) is employed, but weighted combination may be performed at the time of the combination of the LLRs. Furthermore, in a case where the receive signal is a signal that is re-transmitted, the LLRs until previous time may be retained, and may be combined in the combination module 228.

The decoding module 229 performs error correction decoding on λ^{A}(k) that is an output of the combination module 228. In a case where the repetitious processing for the turbo equalization is not continuously performed, such as when the number of times of repetition reaches a prescribed number of times, the decoding module 229 performs hard decision of the bit LLR for a result of the error correction decoding, and outputs a result of the hard decision as a bit sequence R.

On the other hand, in a case where the repetitious processing is continuously performed, the decoding module 229 makes copies of the bit LLR that results from the decoding, by as much as the number of the transmit antennas 108-1 to 108-M, and inputs the copies into the interleave modules 230-1 to 230-M. In each of the interleave modules 230-1 to 230-M, bit rearrangement is performed on the bit LLR that is input, in accordance with the interleave sequence that is designated by the interleave sequence generation module 233. That is, each of the interleave modules 230-1 to 230-M implements the same bit rearrangement as is implemented in the corresponding interleave module 105, among the interleave modules 105-1 to 105-M of the base station device 100, on the bit LLR that is input. For example, in the interleave module 230-1, the same rearrangement as in the interleave module 105-1 is performed, and in the interleave module 230-2, the same rearrangement as in the interleave module 105-2 is performed.

The symbol replica generation modules 231-1 to 231-M implement modulation on the bit LLR on which each of the interleave modules 230-1 to 230-M performs the rearrangement, using the modulation scheme that is employed in the base station device 100, and generate the replica of the signal that is transmitted from each of the transmit antennas 108-1 to 108-M. Moreover, it is assumed that the replica which is generated at this point is a soft replica that has amplitude which is proportional to an expected value that is generated from bit LLR. The replica generation module 232 generates the replica of the receive signal in each of the receive antennas 201-1 to 201-N, using the replicas for all the transmit antennas, which are output from the symbol replica generation modules 231-1 to 231-M, and a channel estimation value that is input from the channel state estimator 203. The replica of the receive signal that is generated in the replica generation module 232 is input into the cancellation modules 221-1 to 221-N, and is subtracted from the receive signal in the cancellation modules 221-1 to 221-N. The reception processing is performed by repeating these processing operations.

Like the interleave sequence generation module 104 in FIG. 2, the interleave sequence generation module 233 generates the interleave sequence Πₘ (m=1, 2, and so forth up to M) in accordance with the control parameter ρ that is determined by the interleave control module 204, and inputs a result of the generation into a corresponding module among the deinterleave modules 227-1 and so forth up to 227-M and a corresponding module among the interleave modules 230-1 to 230-M.

The interleave control module 204 determines a value, that is, the control parameter ρ that is notified to the base station device 100, using the frequency response of the channel that is estimated in the channel state estimator 203. As described above, the control parameter ρ is a ratio for the bit on which interleave that is different between the layers is performed, in the coded bit sequence that is generated in the base station device 100. In a case where different interleave is used, because the signal that is transmitted with each layer is received, as a transmission symbol sequence that is based on different symbol mapping, in the terminal device 200, one piece of information is spread onto multiple symbols, and thus an improved code diversity effect can be achieved. On the other hand, because the signals in the multiple layers that are transmitted by different interleave cause interference with each other in the terminal device 200, in a case where it is impossible to remove the interference, this is a cause of performance degradation. Therefore, the interleave control module 204 estimates ρ for removing the interference, from an ability of the repetition processing module 207 to remove the interference, and from the frequency response of the channel that is input from the channel state estimator 203, and outputs a result of the estimation to the control information generation module 205.

As a method of estimating ρ, an arbitrary method may be used, but for example, a method is described that is based on an extrinsic information transfer (EXIT) chart that results from visually analyzing an exchange of the coded bit LLR between the combination module 228 and the decoding module 229 from the cancellation modules 221-1 to 221-N in the repetition processing module 207. One example of the EXIT charge is illustrated in FIG. 17. The horizontal axis (a decoder MI) of FIG. 17 indicates an amount of mutual information (MI) of the LLR that is output from the decoding module 229, that is, an amount of mutual information that is input, as the replica, into the cancellation modules 221-1 to 221-N. The vertical axis (a demapper MI) of FIG. 17 is an amount of mutual information of the LLR that is output from the combination module 228, that is, an amount of mutual information that is input into the decoding module 229.

Dashed line L1 on FIG. 17 indicates a decoder curve that results when a prescribed coding rate is used, and indicates a value of (the horizontal axis) an amount of mutual information that is obtained when the amount of mutual information on the vertical axis is input into the decoding module 207. Furthermore, solid line L2, solid line L3, and solid line L4 are demapper curves that result in a case where the control parameter ρ of the interleave is set to be each of ρ=0, ρ=½, and ρ=1, and indicate a value (the horizontal axis) of an amount of mutual information of an output of the combination module 228, which results when the amount of mutual information on the vertical axis is fed back, as the replica, to the cancellation modules 221-1 to 221-N. Therefore, when repetitious processing is performed for the first time, that is, in a case where the replica is not present in the cancellation modules 221-1 to 221-N, an amount of mutual information of the LLR that is output from the combination module 228 is a value on the solid lines L2 to L4 when a point on the horizontal axis is 0.

Furthermore, a value on the dashed line L1 on the horizontal axis with the amount of mutual information on the vertical axis is an amount of mutual information that is output from the decoding module 229, and is reliability of the replica that is generated, that is, an amount of mutual information that is input into the cancellation modules 221-1 to 221-N after the repetitious processing is performed. Therefore, as long as the dashed line L1 and the solid lines L2 to LA do not intersect, this means that reliability of the post-decoding LLR that results from the repetitious decoding is improved.

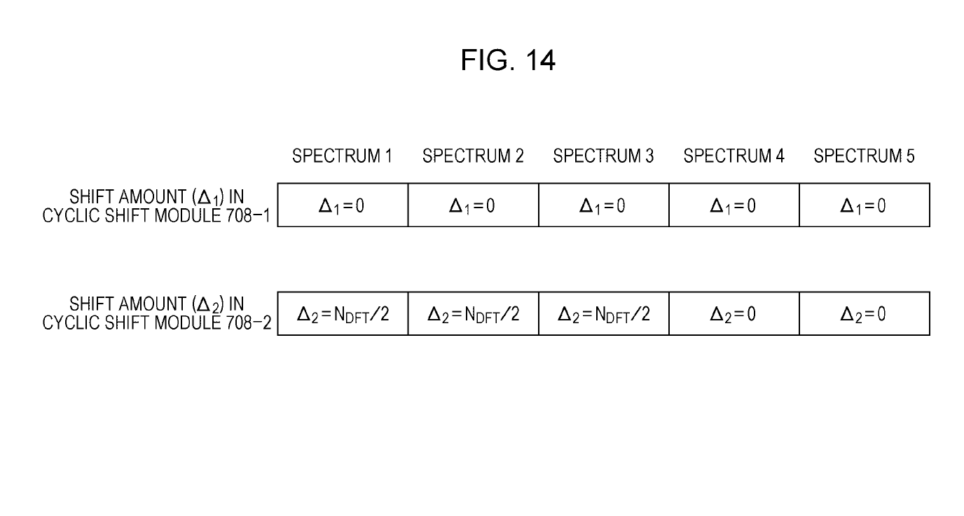

At this point, when the solid lines L2, L3, and LA are compared, it is understood that the solid lines L2 and L4 intersect the dashed line L1, and that an amount of mutual information is not increased while the repetitious decoding is in progress (this state is referred to as stacking). To be more precise, at this point, in a case where the same interleave is used between the layers with ρ=0, or in a case where different interleave is all used between the layers with ρ=1, this means that an error occurs without the post-decoding LLR obtaining sufficient reliability. Therefore, from an example in FIG. 14, it is understood that an error rate for the repetitious decoding can be reduced by using the solid line L3, among the three solid lines L2, L3, and L4, and that if setting is provided to achieve ρ=0.5, this may be sufficient.

In this manner, on the EXIT chart, the demapper curve that changes with a parameter ρ and the decoder curve that is based on the coding rate which is used are compared, and a suitable ρ can be estimated by selecting the demapper curves that do not intersect. However, these curves have characteristics that change with phasing or noise, and even in a case where the intersection does not occur, the closer the curves are to each other the higher a probability that the stacking will occur while the repetitious processing is in progress. Therefore, it is effective to compare an ending point of the demapper curve that is determined by a value ρ as a reference for determining ρ, and an ending point of the decoder curve with each other. The ending point here is defined as a point at which an amount of mutual information that is input is 1 on the demapper curve and a point at which an amount of mutual information that is output is 1 on the decoder curve. However, each of the ending points here is defined as 1, but for example, a different value, such as 0.999, may serve as a reference. Then, a minimum ρ is selected that satisfies a condition that an amount of mutual information that is output at the ending point of the demapper curve>an amount of mutual information that is input at the ending point of the decoder curve. By selecting ρ in this manner, it is possible to exchange the amount of the mutual information until the ending point while suppressing a likelihood that the stacking will occur particularly at the opening the repetitious processing. Furthermore, the ending point of the demapper curve generally satisfied Equation (5) that follows.

[Math. 5]

I_{end}(ρ)=ρI_{end}(1)+(1−ρ)I_{end}(0) (5)

In Equation (5), I_{end}(ρ) is an amount of mutual information that is output at the ending point of the demapper curve when ρ is used. Moreover, I_{end}(0) is an amount of mutual information that is output at the ending point of the demapper curve in a case where ρ=0, that is, in a case where the same interleave is used between the layers, and I_{end}(1) is an amount of mutual information that is output at the ending point of the demapper curve in a case where ρ=1, that is, in a case where different interleave is all used between the layers. These can be calculated by using a J function. Equation (5) is an equation for calculating an ending point for a different value ρ from I_{end}(0) and I_{end} (1) on the assumption that an amount of mutual information that is output, of the demapper curve is in proportion to a value ρ. Therefore, in addition to calculating I_{end} (0) and I_{end}(1) from the channel state information, from Equation (5), the interleave control module 204 sets a minimum value, which is greater than the amount of mutual information that is input at the ending point of the decoder curve, to ρ. Moreover, the interleave control module 204 may be set to store a table in advance, in which each value that the channel state information can take is associated with values of I_{end}(0) and I_{end}(1), and to acquire I_{end}(0) and I_{end}(1) using the table.

The control information generation module 205 generates control information from the control parameter ρ of the interleave that is input from the interleave control module 204, and after converting the resulting control information into a wireless signal as an uplink control signal, transmits the wireless signal from the transmit antenna 206 to the base station device 100 at a prescribed transmission timing. However, included in the control information that is generated from ρ may be different arbitrary control information that is notified to the base station device 100, such as channel state information between a channel between the base station device 100 and the terminal device 200 or information indicating whether or not reception of a downlink signal is established.

However, according to the present embodiment, a configuration is employed in which the terminal device 200 includes the interleave control module 204 and ρ is selected in the interleave control module 204, but the interleave control module 204 may be included in the base station device 100. In this case, the base station device 100 selects ρ based on the channel state information that is notified from the terminal device 200 or on different control information, in the same manner as in the interleave control module 204 described above, and thus the same operation as in the present embodiment can be realized. Furthermore, ρ may be determined with arbitrary information that is known to the base station device 100.

Furthermore, according to the present embodiment, an example is described in which even in a case where any ρ is used, the signals are demultiplexed by the MIMO demultiplexing module, and the LLRs are combined in the combination module 228, but a configuration may be employed in which in a case where the same spectrum is transmitted in all of the transmit antennas of the base station device 100, the LLR is calculated using the signal that is obtained by performing combination at a maximum ratio, without demultiplexing by the MIMO demultiplexing module 223 the signals that are transmitted by the respective transmit antennas, and the calculated LLR is input into the decoding module 229. In this case, an amount of computation can be prevented from being increased due to the repetitious processing.

Moreover, according to the present embodiment, a configuration is employed in which in the base station device 100, the signal in each layer is transmitted from the corresponding transmit antenna, but a configuration may be employed in which a signal that is transmitted from each transmit antenna is generated by multiplying an output of each of the frequency mapping modules 112-1 to 112-M by the precoding matrix. With this configuration, in the same manner as with the present embodiment, the MIMO demultiplexing is performed on the signals that are transmitted in multiple layers, and then the signals are combined in the combination module 228. Thus, the combination can be performed with efficiency.

Furthermore, according to the present embodiment, an example is described in which the signal that is configured from the same coded bit sequence is transmitted in all the transmit antennas, but this does not impose any limitation. For example, in the base station device 100 that includes four antennas, a transmission method that is described according to the present embodiment is applied to the three transmit antennas, and the coded bit sequence that is obtained by coding a different coded bit sequence is transmitted in the remaining one antenna. To be more precise, technologies that are generally referred to as spatial multiplexing can be combined.

In this manner, the base station device 100 that is the transmission device according to the present embodiment performs the interleave on the same coded bit in every layer to use, transmits the OFDM signal, and then transmits the generated OFDM signal from the transmit antenna corresponding to each layer. At this time, for an interleave pattern that is used in each layer, the rearrangement to a position that is different between the layers is performed on the bit with a prescribed ratio, and the rearrangement of other bits in the same position between the layers is performed. By performing this interleave processing, the interference between the layers can be suppressed for the bit on which the rearrangement in the same position is performed while achieving an improved diversity effect for the bit on which the rearrangement in the position that is different between the layers is performed. Therefore, by suitably controlling a prescribed ratio described above, in the repetitious processing in the terminal device 200 that is the reception device, while reducing residual interference between the layers, the improved diversity effect can be obtained and the transfer can be performed with improved spectral efficiency.

### Second Embodiment

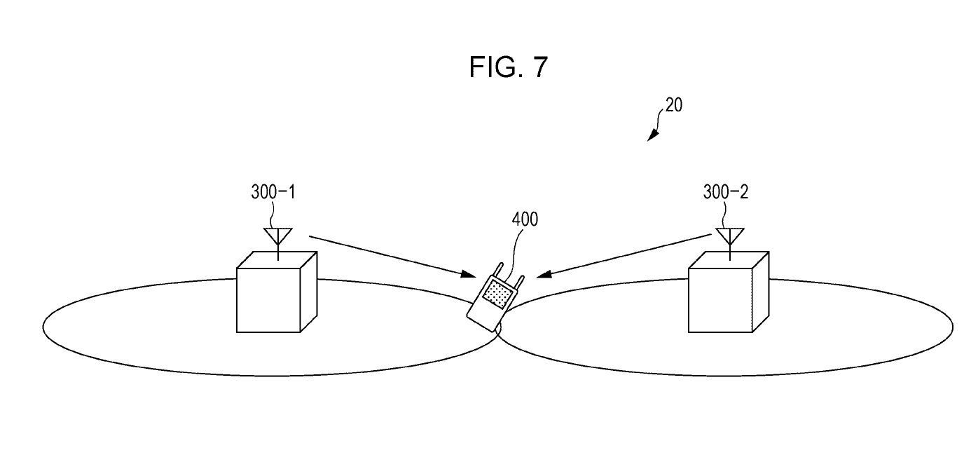

A second embodiment of the present invention will be described below referring to the drawings. FIG. 7 is a schematic diagram illustrating a configuration of wireless communication system 20 according to the present embodiment. The wireless communication system 20 performs coordinated multi point transmission and reception (CoMP) for downlink. That is, two base station devices 300-1 and 300-2 transmit the same data to one terminal device 400. At this point, a first base station device 300-1 and a second base station device 300-2 have the same configuration, but the rearrangement patterns can be set to be different from each other in the interleave that is included in each of the first base station device 300-1 and the second base station device 300-2. Furthermore, the terminal device 400 has the same configuration as the terminal device 200 according to the first embodiment.

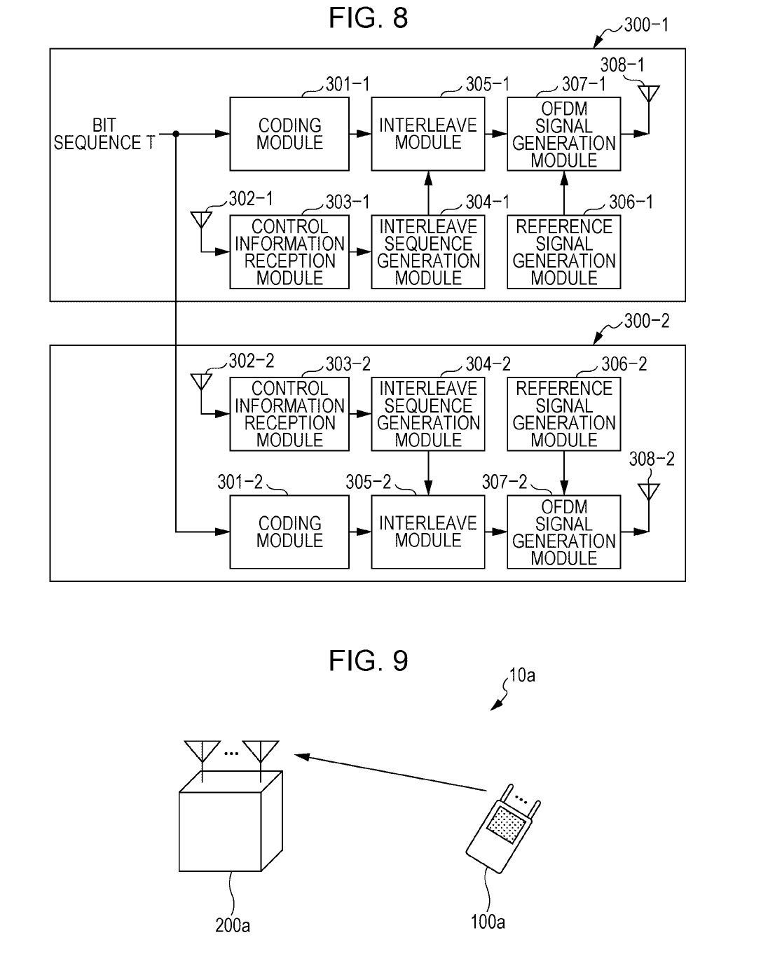

FIG. 8 is a schematic block diagram illustrating a configuration of the base station device 300-1 and 300-2.

The base station device 300-1 is configured from a coding module 301-1, a receive antenna 302-1, a control information reception module 303-1, an interleave sequence generation module 304-1, an interleave module 305-1, a reference signal generation module 306-1, an OFDM signal generation module 307-1, and a transmit antenna 308. The base station (at this point, the base station device 300-2) that cooperates with the base station 300-1 has the same configuration as well, and a branch number of each module is indicated by *−2.

The same information bit sequence T is input into the coding module 301-1 and 301-2 that are included in the base station devices 300-1 and 300-2, respectively, and the same coding processing is implemented. However, in FIG. 8, the bit sequence T is shared between two base station devices, that is, the base station devices 300-1 and 300-2, but a configuration may be employed in which the other base station device is notified of the coded bit sequence that results from performing the coding processing in any coding module without sharing the bit sequence T. In this case, an amount of information that is shared between the base stations increases, but the coding processing can be omitted in one base station device.

The control information reception module 303-1 receives the control information that is destined for the base station device 300-1 and that is transmitted from the terminal device 400, through the receive antenna 302-1. The control parameter ρ of the interleave sequence is included in the control information, and the control information reception module 303-1 inputs the ρ into the interleave sequence generation module 304-1. However, other pieces of information that are notified by the terminal device 400 may be included in the control information. Furthermore, the control parameter ρ that is output from the control information reception module 303-1, and the control parameter ρ that is output from the control information reception module 303-2 are the same. Therefore, because the receive antennas 302-1 and 302-2, and the control information reception modules 303-1 and 303-2 perform the same processing respectively, a configuration may be employed in which the processing is performed only in any of the base station device 300-1 and the base station device 300-2 and ρ that is output is input into the interleave sequence generation modules 304-1 and 304-2.

The interleave sequence generation module 304-1 generates the interleave sequences Π₁ that are used in the interleave module 305-1, according to a transmission parameter for a sequence length of a coded bit (that is output from the coding module 301-1) that is input into the interleave modules 305-1, a user identification number, or the like, and the control parameter ρ that is input from the control information reception module 303-1.

At this point, when each base device is regarded as one layer, the interleave sequence Π₁ that is generated in the interleave sequence generation module 304-1 of the base station device 300-1, and the interleave sequence π₂ that is generated in the interleave sequence generation module 304-2 of the base station device 300-2 are the same as is the case where M of Πₘ that is generated in the interleave sequence generation module 104 according to the first embodiment is assumed to be the number of base station devices. That is, Πₘ=[π_{m,1}, π_{m,2}, . . . , π_{m,q}, . . . , π_{m,Nc}]^{T}, and π_{m,q} is a vector that indicates which pre-interleave bit a post-interleave q-th bit is in the m-th base station device 300-m. Accordingly, if π_{1,q}=π_{2,q} is given, this indicates the q-th bit that is output from the interleave module 305-1, and the q-th bit that is output from the interleave module 305-2 are the same.

The interleave sequence generation modules 304-1 and 304-2 control a ratio of q that attains π_{1,q}=π_{2,q} among the interleave sequences Π₁ and Π₂, in according to the control parameter ρ that is input by the control information reception module 303-1 and 303-2. ρ takes a value ranging from 0 to 1. ρ is a ratio that attains π_{1,q}≠π_{2,q} between the base station devices, and is a ratio at which (1−ρ) is π_{1,q}=π_{2,q} between the base station devices. Therefore, in a case where ρ=0, the bit sequences that are output from the interleave modules 305-1 and 305-2 are the same sequences that results from the same interleave. In a case where ρ=1, the bit sequences that are output from the interleave modules 305-1 and 305-2 are sequences that are different from each other.

In a case where 0<ρ<1, a rule for which row in a matrix Πₘ a vector that is set to be the same as a different layer is positioned in may be arbitrarily prescribed in the system. For example, first to (1−ρ) N_{c}-th numbers may be set to be the same in the number N_{c} of rows. Among Nₛ modulation symbols that are generated from N_{c} coded bits in modulation modules 111-1 and 111-2 within the OFDM signal generation modules 307-1 and 307-2, rows that correspond to the coded bits that are equivalent to first to (1−ρ) Nₛ-th symbols may be the same. Furthermore, in a case where (1−ρ) N_{c} or (1−ρ) Nₛ is not an integer, the smallest integer that is equal to or greater than (1−ρ) N_{c} or is equal to or greater than (1−ρ) Nₛ may be prescribed using a ceiling function. However, the rule is known to the terminal device 400 that is a reception device.

However, in FIG. 8, interleave sequence generation modules 304-1 and 304-2 are present independently of each other, but there is a need to satisfy a relationship between Π₁ and Π₂ described above. For this reason, an operation may be performed in such a manner that communication is performed between the interleave sequence generation modules 304-1 and 304-2 and synchronization is gained, or a configuration may be employed in which Πₘ's of all the base station devices with which any of the interleave sequence generation modules 304-1 and 304-2 cooperate are generated, and Π₁ and Π₂ are notified to the interleave module 305-1 and 305-2 of each base station device, respectively.

In the interleave modules 305-1 and 305-2, rearrangement of a bit sequence of coded bits is performed in accordance with the interleave sequences that are notified from the interleave sequence generation modules 304-1 and 304-2 to each of the interleave modules 305-1 and 305-2, respectively. For example, in a case where the coded bit sequence that is input by the coding modules 301-1 and 301-2 is expressed with vector c=[c₁, c₂, and so forth up to c_{Nc}]^{T}, processing in the interleave module 305-m can be realized by Equation (6) that follows, using a matrix Πₘ that is input by the interleave sequence generation module 304-m. However, vector c′ₘ is a post-interleave bit sequence that is output by the interleave module 305-m.

[Math. 6]

c′ₘ=Πₘc (6)

Moreover, according to the present embodiment, the interleave processing in the interleave sequence generation module 304-m and the interleave module 305-m is indicated by the matrix operation, but the same processing may be realized by an arbitrary circuit. The coded bit sequence, on which the interleave is implemented in the interleave module 305-m, is output to the OFDM signal generation module 307-m.

In the reference signal generation modules 306-1 and 306-2, the reference signal that mutually intersects a different base station is generated from a reference signal sequence that is mutually shared. This is because channel performance can be estimated from all the base stations that cooperate in the terminal device 400. The generated reference signal is output to each of the OFDM signal generation modules 307-1 and 307-2.

Because the OFDM signal generation module 307-1 and the OFDM signal generation module 307-2 can be realized with the same configuration as is illustrated in FIG. 3 that illustrates the configuration of the OFDM signal generation module 107-m according to the first embodiment, a description thereof is omitted. However, differences are as follows. The bit sequence that is input into the modulation module 111-m in FIG. 3 is input from the interleave module 305-m. The reference signal that is input into the frequency mapping module 112-m in FIG. 3 is input from the reference signal generation module 306-m. The transmit signal that is output by the wireless transmission module 115-m in FIG. 3 is transmitted through the transmit antenna 308-m.

The transmit signals that are output from the OFDM signal generation modules 307-1 and 307-2 are transmitted to the terminal device 400 through the transmit antennas 308-1 and 308-2, respectively.

At this point, with regard to a method of sharing the bit sequence, the interleave sequence, and the reference signal sequence that are shared between the base station device 300-1 and the base station device 300-2 that cooperates with the corresponding base station, for example, the sharing may be performed using wire X2 interface that is specified in LTE and the like and the sharing may be performed through internet protocol (IP) network. Furthermore, if a connection is established between stations using optical fiber, as is the case with remote radio head (RRH) or overhang antenna, the sharing may be performed using the fiber. Furthermore, according to the present embodiment, the cooperation is performed between the base station devices, but any method in which multiple transmission points (relay station devices, femto base station devices, or pico base station devices) cooperate with each other to transmit the same data can be applied. Furthermore, in the same manner, it is possible to apply a case where three or more base station devices or three or more transmission points cooperate with each other.

A configuration of the terminal device 400 is the same as that of the terminal device 200 in FIG. 4. That is, according to the present embodiment, as is the case with the first embodiment, the signals that are transmitted in multiple layers are combined after the MIMO demultiplexing is performed in the repetition processing module 207. Accordingly, without depending on the channel estimation value that is recognized on the transmission side (the base station devices 300-1 and 300-2), the combination can be performed with efficiency and the transfer can be performed with high spectral efficiency.

Moreover, according to the present embodiment, a configuration is employed in which the signal in each layer is transmitted from each of the base station devices 300-1 and 300-2, but a configuration may be employed in which an output of the frequency mapping module 112-m is multiplied by the precoding matrix and a signal to transmit is generated. Furthermore, a configuration may be employed in which in any of the base stations that cooperate with each other, in the same manner as with the base station device 100, the mapping is performed by the frequency mapping module 112-m, a result of the mapping is multiplied by the precoding matrix, and a signal to transmit from each base is generated. Even with these configurations, in the same manner as with the present embodiment, the MIMO demultiplexing is performed on the signals that are transmitted in multiple layers, and then the resulting signals are combined in the repetition processing module 207. Thus, the combination can be performed with efficiency.

However, according to the present embodiment, the bit interleave that is to perform the interleave in all the coded bit sequences is used as an interleave method, but the interleave may be applied to every subcarrier. Examples of this case, there are an example in which the same interleave pattern in each transmit antenna is applied to multiple prescribed subcarriers and the interleave pattern that is different in each transmit antenna is applied to other subcarriers, and the like.

However, according to the present embodiment, a configuration is employed in which the terminal device 400 includes the interleave control module 204 and ρ is selected in the interleave control module 204, but the interleave control module may be included in the base station device 300. In this case, the base station device 300 selects ρ based on the channel state information that is notified from the terminal device 400 or on different control information, in the same manner as in the interleave control module 204 described above, and thus the same operation as in the present embodiment can be realized. Furthermore, ρ may be determined with arbitrary information that is known to the base station device 300.

Furthermore, according to the present embodiment, an example is described in which even in a case where any ρ is used, the signals are demultiplexed by the MIMO demultiplexing module 223, and the LLRs are combined in the combination module 228, but a configuration may be employed in which in a case where the same spectrum is transmitted in the transmit antennas of all the base station devices, the LLR is calculated using the signal that is obtained by performing combination at a maximum ratio, without demultiplexing by the MIMO demultiplexing module 223 the signals that are transmitted by the transmit antennas, and the calculated LLR is input into the decoding module 229. In this case, an amount of computation can be prevented from being increased due to the repetitious processing.

According to the second embodiment, a transmission method is described above that is used when the same bit sequence T is transmitted from the multiple base station devices 300-1 and 300-2 to one terminal device 400. As described above, the interleave is performed on the same bit sequence T in each of the base station devices 300-1 and 300-2, for the interleave, the rearrangement to a position that is different between the base station devices 300-1 and the 300-2 is performed on the bit with a prescribed ratio in the coded bit sequence, and the rearrangement of other bits in the same position between the base stations is performed. In a case where this method is used, while combining the LLRs for the bits on which the rearrangement to the position that is different in the terminal device 400 is performed, the rearrangement to the same position is performed, and thus the interference between the layers can be suppressed and the reliability of the decoding can be improved. For this reason, the transfer can be performed with high spectral efficiency.

### Third Embodiment

A third embodiment of the present invention will be described below referring to the drawings. A wireless communication system 10a according to the present embodiment performs transmission diversity transfer that does not share the channel state information (CSI) for uplink (transfer from a terminal device 100a to a base station device 200a) that uses a multi-antenna. Moreover, a case where the transfer scheme is discrete Fourier transform spread OFDM (DFT-S-OFDM), not one of the various types of orthogonal frequency division multiplexing (OFDM) according to the embodiments described above is described. FIG. 9 is a schematic diagram illustrating a configuration of the wireless communication system 10a according to the present embodiment. As illustrated in FIG. 9, the wireless communication system 10a is configured to include the terminal device 100a that has M transmit antennas and the base station device 200a that has N receive antennas.

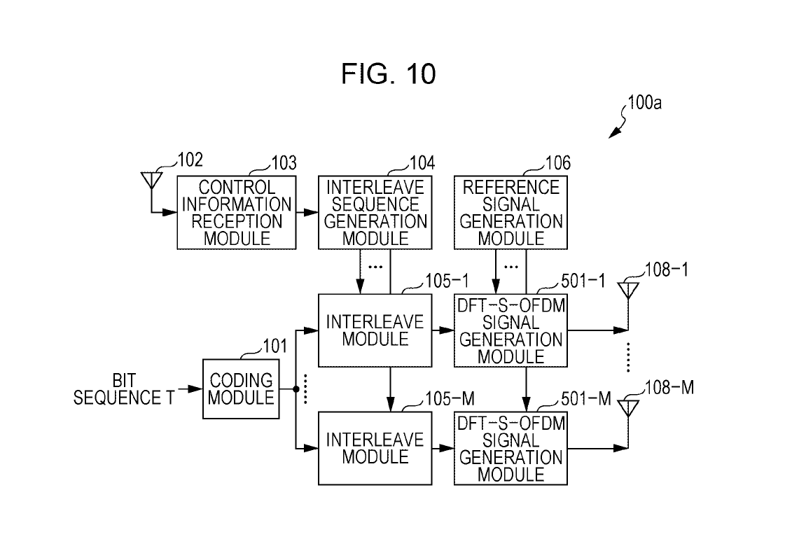

FIG. 10 is a schematic block diagram illustrating a configuration of the terminal device 100a that is a transmission device according to the present embodiment. However, FIG. 10 is a block diagram of only portion relating to the uplink for transmission from the terminal device 100a to the base station device 200a, and a portion that performs downlink communication, and the like are omitted. A configuration of the terminal device 100a that is illustrated in FIG. 10 is almost the same as the configuration of the base station device 100 in FIG. 2, but a difference is that the OFDM signal generation modules 107-1 to 107-M are DFT-S-OFDM signal generation modules 501-1 to 501-M, respectively. Moreover, in FIG. 10, a portion corresponding to each module in FIG. 2 is given the same reference numeral, and a description thereof is omitted.

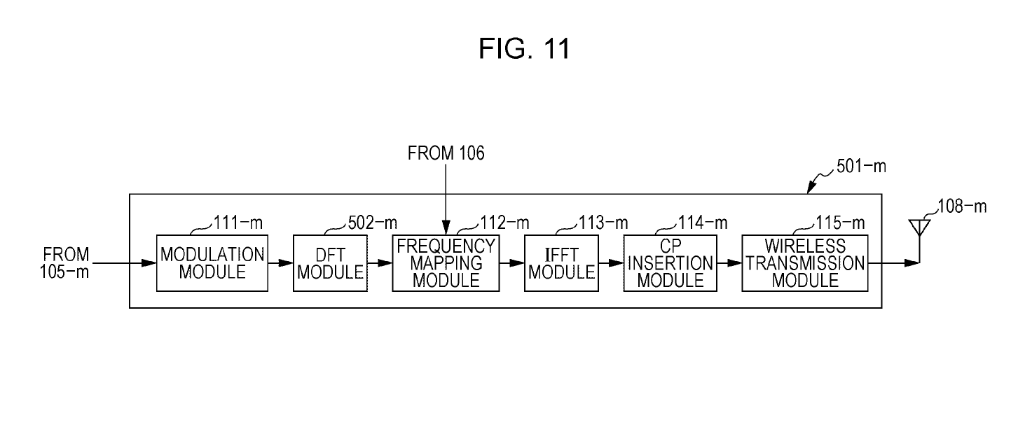

FIG. 11 is a schematic block diagram illustrating an internal configuration of the DFT-S-OFDM signal generation module 501-m (m=1, 2, and so forth up to M). FIG. 11 illustrates the same internal configuration as that of the OFDM signal generation module 107-m in FIG. 3, but a difference is that the output of the modulation module 111-m is input into the frequency mapping module 112-m through a DFT module 502-m. Moreover, in FIG. 11, a portion corresponding to each module in FIG. 3 is given the same reference numeral, and a description thereof is omitted. The DFT module 502-m implements discrete Fourier transform on a sequence of modulation symbols that are generated by the modulation module 111-m, and generates a signal (data spectrum) in the frequency domain.

In this manner, an advantage is obtained in that in the terminal device 100a, the discrete Fourier transform (DFT) is applied to the modulation symbol and thus a temporal waveform of the transmit signal has lower peak-to-average power ratio (PAPR) performance than with the OFDM. Furthermore, the reference signal that is generated in the reference signal generation module 106 is also different than for downlink. Not only de-modulation (DM)-RS that is the reference signal which is used for demodulation but also a sounding RS (SRS) that is the reference signal for determining a band which is used for transfer is generated, and each of the generated DM-RS and SRS is mapped to time and frequency resources in the frequency mapping module 112-m. Moreover, in the same manner as is the case with the OFDM, the arrangement of the data spectrum in the frequency mapping module 112-m may be contiguous and may be non-contiguous.

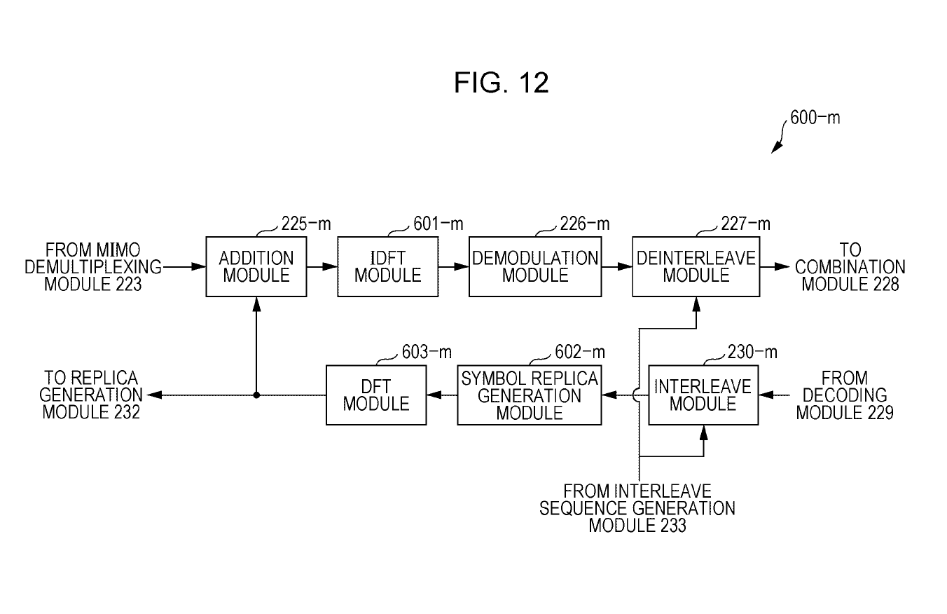

The base station device 200a receives the signal that is transmitted by the terminal device 100a in FIG. 10, and a configuration thereof is the same as that of the terminal device 200 in FIG. 4. However, in FIG. 6 that illustrates the internal configuration of the repetition processing module 207 in FIG. 4, a difference is that instead of the layer processing module 224-m (m=1, 2, and so forth up to M), a layer processing module 600-m (m=1, 2, and so forth up to M) is retained. FIG. 12 is a schematic block diagram illustrating an internal configuration of the layer processing module 600-m. There are three differences between the layer processing module 600-m in FIG. 12 and the layer processing module 224-m in FIG. 6.

A first difference is that inverse DFT is performed by an IDFT module 601-m on an output of the addition module 225-m and then a result of performing the inverse DFT is input into the demodulation module 226-m. A second difference is that instead of the symbol replica generation module 231-m, a symbol replica generation module 602-m is retained. As in the symbol replica generation module 231-m in FIG. 6, in a case of the OFDM signal, the bit LLR that is input into the symbol replica generation module 231-m is assumed to be an expected value of a direct symbol replica. However, because in the symbol replica generation module 602-m, corresponding to the DFT-S-OFDM, that is, single carrier transmission is performed, and reverse spread of the modulation symbol by IDDT is present, the difference is that an average value of the bit LLR that is input into the symbol replica generation module 602-m is assumed to be an estimated value of each symbol replica. A third difference is that the discrete Fourier transform is performed by a DFT module 603-m on an output of the symbol replica generation module 602-m, and then the resulting output is input into the replica generation module 232 and the addition module 225-m.

Like the terminal device 200 in FIG. 6, the base station device 200a performs the MIMO demultiplexing on signals that are transmitted in multiple layers, and then the resulting signals are combined in the combination module 228. Accordingly, without depending on the channel estimation value that is recognized on the transmission side (the terminal device 100a), the combination can be performed with efficiency and the transfer can be performed with high spectral efficiency. In this manner, even in a case where the single carrier transmission is used, the same effect as in the first and second embodiments can be obtained.

### Fourth Embodiment

A fourth embodiment of the present invention will be described below referring to the drawings. A case is described where according to the third embodiment, in the same manner as in the first and second embodiments, the interleave in which at least a portion of the interleave sequence that is different between the layers is applied to the same bit sequence and thus multiple difference signals are generated, and these signals are transmitted in a state of being spatially multiplexed. However, according to the present embodiment, as a method of obtaining the same effect, a method of performing the interleave (rearrangement of the spectrum) in the frequency domain is used. A configuration example thereof will be described below.

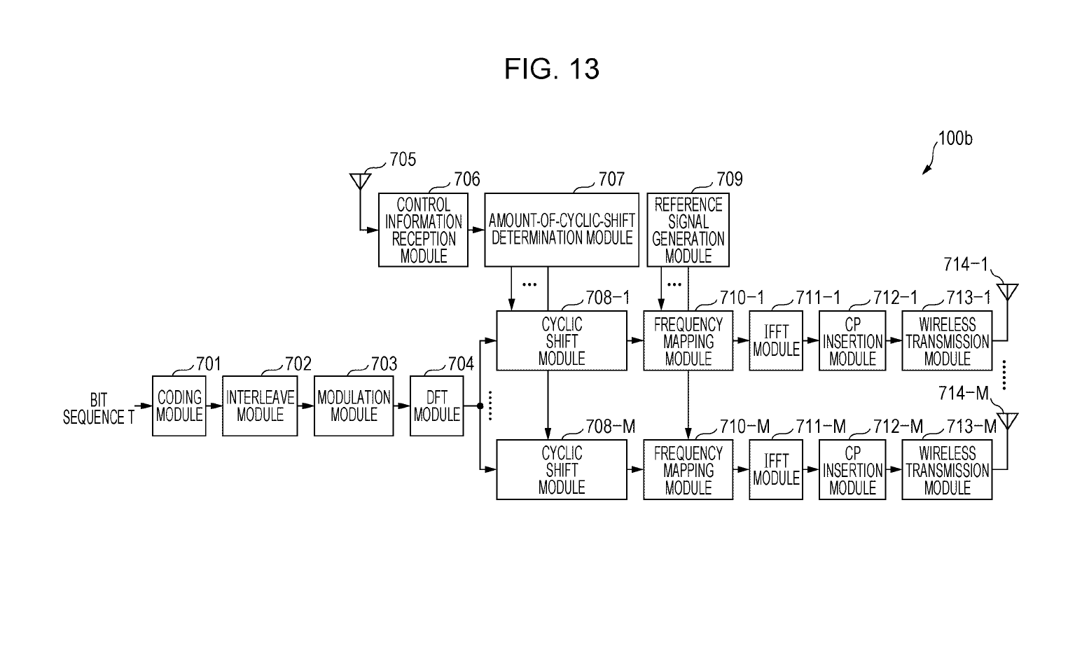

Like the wireless communication system 10a in FIG. 9, a wireless communication system 10b according to the present embodiment is configured to include a terminal device 100b that has M transmit antennas, and a base station device 200b that has N receive antennas. FIG. 13 is a schematic block diagram illustrating a configuration of the terminal device 100b.

The terminal device 100b is configured to include a coding module 701, an interleave module 702, a modulation module 703, a DFT module 704, a receive antenna 705, a control information reception module 706, an amount-of-cyclic-shift determination module 707, M cyclic shift modules 708-1 to 708-M, a reference signal generation module 709. M frequency mapping modules 710-1 to 710-M. M IFFT modules 711-1 to 711-M, M CP insertion modules 712-1 to 712-M. M wireless transmission modules 713-1 to 713-M, and M transmit antenna 714-1 to 714-M.

The coding module 701, the receive antenna 705, the control information reception module 706, the reference signal generation module 709, and the transmit antennas 714-1 to 714-M in FIG. 13 have the same functions as the coding module 101, the receive antenna 102, the control information reception module 103, the reference signal generation module 106, and the transmit antenna 108-1 to 108-M in FIG. 10, respectively. Furthermore, the modulation module 703, the DFT module 704, the frequency mapping modules 710-1 to 710-M, the IFFT modules 711-1 to 711-M, the CP insertion modules 712-1 to 712-M, and the wireless transmission modules 713-1 to 713-M in FIG. 13 have the same functions as the modulation module 111-m, the DFT module 502-m, the frequency mapping module 112-m, the IFFT module 113-m, the CP insertion module 114-m, and the wireless transmission module 115-m in FIG. 11, respectively. Therefore, descriptions of functions of these blocks are omitted.

In the terminal device 100b, an output of the coding module 701 is input into the interleave module 702. In the interleave module 702, prescribed interleave common to each layer is applied to the output (the coded bit sequence) of the coding module 101. Then, that same spectrum that is the single carrier spectrum that is generated through the modulation module 703 and the DFT 704 is input into the cyclic shift modules 708-1 to 708-M.

The amount-of-cyclic-shift determination module 707 determines a shift amount of cyclic shift that is performed in each of the cyclic shift modules 708-1 and 708-M. At this point, the cyclic shift illustrates a cyclic shift in the frequency domain. For example, in a case where the single carrier spectrum that is input from the DFT module 704 is S(k) (0≦k≦N_{DFT}−1), and the amount of cyclic shift is Δ, an output S′(k) (0≦k≦N_{DFT}−1) of each of the cyclic shift modules 708-1 to 708-M is expressed with Equation (7) that follows.

[Math. 7]

S′(k)=S((k+Δ)mod N_{DFT}) (7)

The control parameter ρ that is an output of the control information reception module 706 is input into the amount-of-cyclic-shift determination module 707, and switching of the shift amount is performed based on the ρ. Specifically, the control parameter ρ that is input is a ratio of symbols that are given the amounts of cyclic shift that are different within the layers to multiple single carrier symbols (DFT-S-OFDM symbols) that are generated from one coded bit sequence.

FIG. 14 illustrates one example of the amount of cyclic shift that is set in a case where a size of DFT for generating the single carrier spectrum is assumed to be N_{DFT}, the number of spectra that are generated from one coded bit sequence is assumed to be 5, the number of layers is assumed to be 2, and the control parameter ρ=0.6 is assumed to be established. In FIG. 14, five spectra, that is, a spectrum 1 to a spectrum 5, which are generated from the same coded bit sequence are input into the cyclic shift modules 708-1 and 708-2.

At this time, an amount Δ₁ of cyclic shift that is set in the cyclic shift module 708-1 is always set to 0 in each spectrum, and an amount Δ₂ of cyclic shift that is set in the cyclic shift module 708-2 is set to N_{DFT}/2 in the spectrum 1 to spectrum 3 and is set to 0 in the spectrum 4 and the spectrum 5. Accordingly, a difference in the shift amount between the two layers is N_{DFT}/2 in the spectrum 1 to the spectrum 3, and is 5 in the spectrum 4 and the spectrum 5. In this manner, the amount of cyclic shift of each layer that is set for every spectrum is input into the cyclic shift modules 708-1 and 708-M, shift processing is performed on the amount of cyclic shift based on Equation (7), and a result of the shift processing is output to the frequency mapping modules 710-1 to 710-M.

Moreover, according to the present embodiment, the cyclic shift is performed based on the fact that the cyclic shift in the frequency domain does not have an influence on the PAPR in the temporal waveform, but if the PAPR does not pose any problem, a configuration may be employed in which the interleave is performed on a frequency spectrum. In this case, as in the present embodiment, the switching between applying the same interleave between the layers to the frequency spectrum and applying the different interleave to the frequency spectrum may be performed for every single carrier symbol, or control may be performed in such a manner that a ratio of a band in which different interleave is performed within one single carrier symbol is set to be ρ. Furthermore, even in a case where the cyclic shift is used, cyclic shift processing may be performed only on the spectrum with a ratio that is indicated with ρ among the single carrier spectra in one single carrier symbol.

Thereafter, the same processing as in the terminal device 100a in FIG. 10 is performed, and a result of the processing is transmitted from the transmit antennas 714-1 to 714-M.

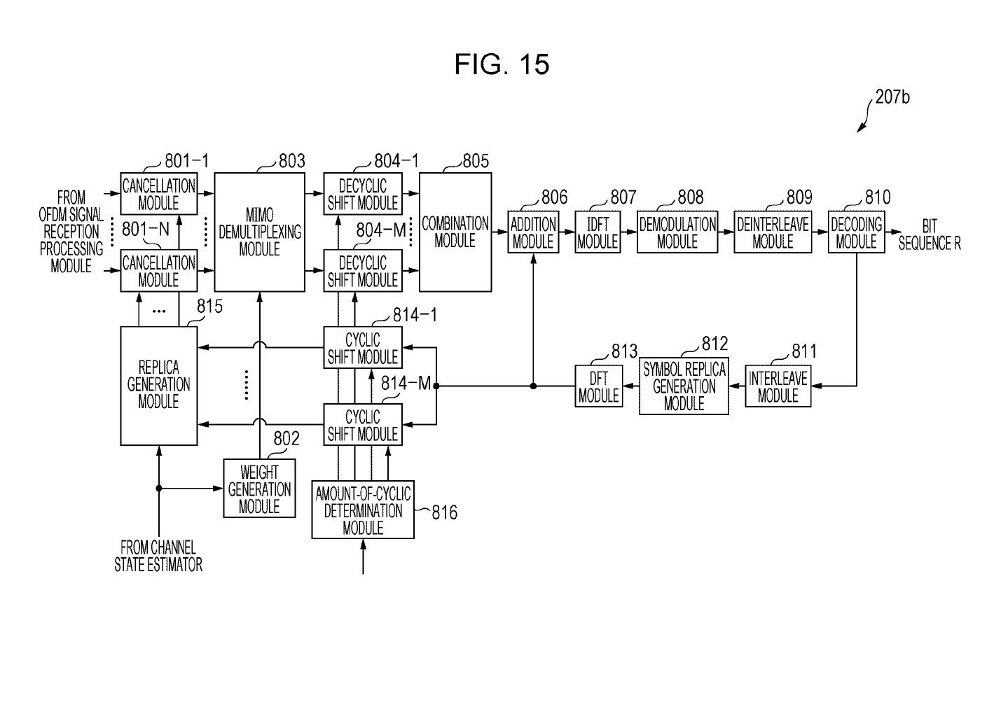

A configuration of the base station device 200b according to the present embodiment is basically the same as that of the terminal device 200 in FIG. 4, but a difference is that the changing to the repetition processing module 207 takes place and a repetition processing module 207b is retained. FIG. 15 is a schematic block diagram illustrating a configuration of the repetition processing module 207b. The repetition processing module 207b is configured to include cancellation modules 801-1 to 801-N, a weight generation module 802, a MIMO demultiplexing module 803, de-cyclic shift modules 804-1 to 804-M, a combination module 805, an addition module 806, an IDFT module 807, a demodulation module 808, a deinterleave module 809, a decoding module 810, an interleave module 811, a symbol replica generation module 812, a DFT module 813, cyclic shift modules 814-1 to 814-M, a replica generation module 815, and an amount-of-cyclic-shift determination module 816.

At this point, the cancellation modules 801-1 to 801-N, the weight generation module 802, the MIMO demultiplexing module 803, the decoding module 810, and the replica generation module 815 have the same functions as the cancellation modules 221-1 to 221-N, the weight generation module 222, the MIMO demultiplexing module 223, the decoding module 229, and the replica generation module 232 in FIG. 6. Furthermore, the addition module 806, the IDFT module 807, the demodulation module 808, the symbol replica generation module 812, and the DFT module 813 in FIG. 15 have the same function as the addition module 225-m, the IDFT module 601-m, the demodulation module 226-m, the symbol replica generation module 602-m, and the DFT module 603-m in FIG. 12. Furthermore, the amount-of-cyclic-shift determination module 816 has the same function as the amount-of-cyclic-shift determination module 707 in FIG. 13.

Therefore, descriptions of these blocks are omitted. However, the control parameter ρ is input from the interleave control module 204 into the amount-of-cyclic-shift determination module 816.

Signals in layers that results from the multiplexing in the MIMO 803 are input into corresponding de-cyclic shift modules 804-1 to 804-M, respectively. For example, the signal in the layer that corresponds to the transmit antenna 714-1 in FIG. 13 is input into the de-cyclic shift module 804-1, and the signal in the layer that corresponds to the transmit antenna 714-M is input into the de-cyclic shift module 804-M. Each of the de-cyclic shift modules 804-1 to 804-M performs processing that returns the cyclic shift which is designated from the amount-of-cyclic-shift determination module 816 to its original state, on the signal that is input from the MIMO demultiplexing module 803. That is, in each of the de-cyclic shift modules 804-1 to 804-M, processing that returns the cyclic shift that is applied in each of the corresponding cyclic shift modules 708-1 to 708-M in FIG. 13 to its original state is performed.

For example, in a case where the single carrier spectrum that is input from the MIMO demultiplexing module 804 is G(k) (0≦k≦N_{DFT}−1), and an amount of cyclic shift in the cyclic shift module 708-1 is Δ, an output G′(k) (0≦k≦N_{DFT}−1) of the de-cyclic shift module 804-1 is expressed with Equation (8).

[Math. 8]

G′(k)=G((k−Δ)mod N_{DFT}) (8)

Moreover, in a case where frequency interleave, not the cyclic shift, is applied in the base station device 200b6, processing that returns the sequential order of the frequency spectrum to its original state is performed by performing deinterleave. An output of each of the de-cyclic shift modules 804-1 to 804-M are input into the combination module 805.

In the combination module 805, the spectra that are input from the de-cyclic shift modules 804-1 to 804-M are combined (added up). Because the order in which the spectra are arranged is in place, reception energies can be combined. An output of the combination module 805 is input into the addition module 806.

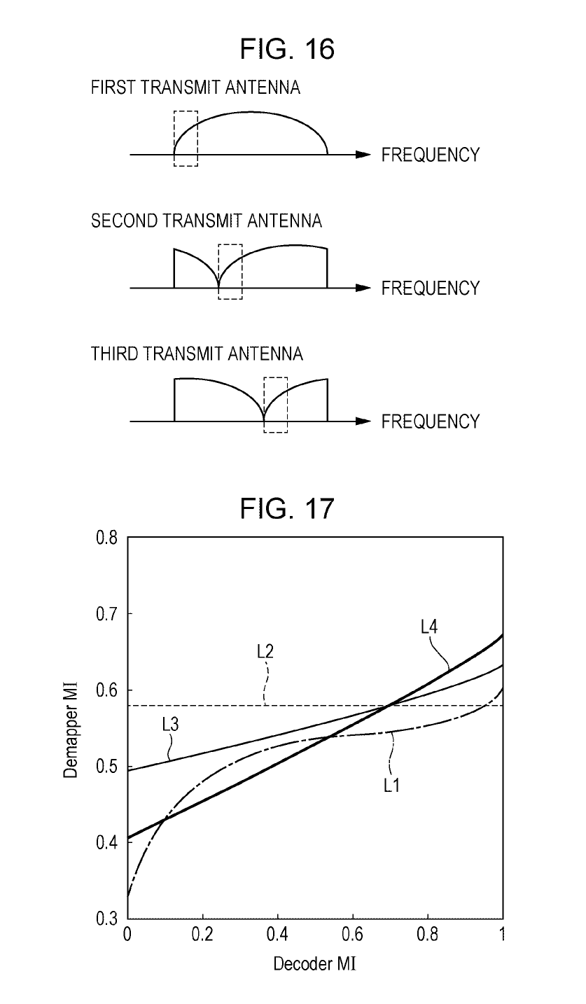

Furthermore, at this point, in a case where a different amount of cyclic shift is set in M transmit antennas, each frequency spectrum is transmitted over a different frequency in every transmit antenna. To be more precise, on the reception device side, the same spectrum is received on M subcarriers. Moreover, in a case where the number of receive antennas is N, the same spectrum is received in M×N places. This is because it is considered that the number of receive antennas is M×N. Performance improvement can be accomplished by changing weight, multiplication to which is performed in the MIMO demultiplexing module 803. For example, in a case where M=3, as illustrated in FIG. 16, a frequency spectrum enclosed by a dotted-line-drawn quadrilateral is transmitted from the corresponding transmit antenna over a different frequency. In this case, because three simultaneous equations for calculating amplitude of the frequency can be created per receive antenna, and each receive antenna can be configured based on this. Thus, 3N simultaneous equations, that is, the number of receive antennas can be regarded as 3N.

The bit LLR that is an output of the demodulation module 808 is input into the deinterleave module 809.

In the deinterleave module 809, processing that is the reverse of the interleave processing that is used in the interleave module 702 in FIG. 13, that is, processing that returns the rearranged state to its original state is performed. The bit LLT that corresponds to the coded bit sequence that is an output of the coding module in FIG. 13 is output to the decoding module 810.

Furthermore, an output of the decoding module 810 is input into the interleave module 811. The same interleave processing as in the interleave module 702 in FIG. 13 is performed on the output and a result of the interleave processing is output to the symbol replica generation module 812. An output of the DFT module 813 is input into the addition module 806 and the cyclic shift modules 814-1 to 814-M.

In each of the cyclic shift modules 814-1 to 814-M, the cyclic shift is performed on the frequency spectrum that is input from the DFT module 813, in accordance with the cyclic shift that is designated from the amount-of-cyclic-shift determination module 816, and a signal that results from performing the cyclic shift is input into the replica generation module 815. That is, in each of the cyclic shift modules 814-1 to 814-M, the same amount of cyclic shift as is applied in each of the corresponding cyclic shift modules 708-1 to 708-M in FIG. 13 is applied.

According to the present embodiment, an example is described in which, when the same information is transmitted from multiple transmit antennas of a transmitter using single carrier transfer, the single carrier spectrum with a prescribed ratio is processed for transmission in such a manner that the single carrier spectrum with the prescribed ratio is a spectrum that is different between the transmit antennas, and other single carrier spectra are transmitted as a spectrum that is the same between the transmit antennas. At this time, the same bit interleave is used between the transmit antennas, and then a different cyclic shift is applied to the frequency spectrum. Thus, the processing is performed in such a manner that the combination of the frequency spectra is performed without the bit LLRs being combined. As a result, the number of times that the IDFT or the modulation is performed can be reduced compared with a case where the bit LLRs are combined.

Furthermore, as described above, the cyclic shift processing is performed only on a specific single carrier spectrum and thus interference between the layers in all coded bit sequences is suppressed. Thus, deterioration in throughput due to the residual interference can be suppressed.

Moreover, of course, a transmission method that uses the cyclic shift, not the interleave, is applicable not only to the single carrier transfer, but also to multi-carrier transfer such as the OFDM. Moreover, in a case of the OFDM, although the frequency interleave is applied, an effect that PAPR performance does not change is achieved.

Moreover, according to the first to fourth embodiments, descriptions are provided on the assumption that the same modulation scheme is applied in each transmit antenna or the base station devices that cooperate with each other, but the interleave or the modulation scheme may be different from one transmit antenna to another or from one base station to another, the interleave may be the same, and only the modulation scheme may be different from one antenna to another or from one base station to another. In such a case, the same effect is achieved. However, in a case where the modulation scheme is changed, for demodulation processing and symbol replica generation, there is a need to perform processing according to the modulation scheme that is used for the transmission. Furthermore, if a coding method in which a systematic bit is present is employed, the coding method may be changed for every antenna or every base station. The coding rate may also be changed in the same manner for every antenna or every base station. Moreover, in a case where the number of transmit antennas or the number of base stations is 3 or greater, a method, such as using two different type of interleave and two different modulation schemes, can also be used. In this manner, an example that results from combining one or several portions of the first to fourth embodiments is also included in the present invention.

The number of antennas and the number of base stations that cooperate with each other are also not limited, and it is possible to set the number of subcarriers, which are used for data transmission in each antenna or the base station, to a different value, or to set the subcarriers to be at different positions. Furthermore, application is also possible in a system that clipping (lack of a frequency component) in the frequency domain is performed on the DFT-S-OFDM.

However, according to the present invention, ρ is defined as a ratio of q that attains π_{1,q}≠ . . . ≠π_{m,q}≠ . . . ≠π_{M,q} among the interleave sequences Π₁ to Π_{M} and as a ratio at which (1−ρ) is π_{1,q}= . . . =π_{m,q}= . . . =π_{M,q}, but an example is also considered in which in a case where the number of layers is 3 or greater, the definition is satisfied only between some of the layers. For example, in a case where M=3, Π₁, Π₂, and Π₃ are present. When N_{c}=4 and ρ=0.5, Πₘ=[π_{m,1}, π_{m,2}, π_{m,3}, π_{m,4}]^{T} is established. At this point, in a first layer and a second layer, π_{1,1}≠π_{2,1} and π_{1,2}≠π_{2,2}, and π_{1,3}=π_{2,3} and π_{1,4}=π_{2,4} are established. At this point, an example is also considered in which in the first layer and a third layer, π_{1,1}=π_{3,1} and π_{1,2}=π_{3,2}, and π_{1,3}≠π_{3,3} and π_{1,4}≠π_{3,4}. In this manner, bits are made to be different using the same interleave as in a different layer for every layer. Thus, concentration of the interference within the layers in some bits can be avoided, and interference power with respect to received power of each bit can be reduced.

A program running on the terminal device and the base station device according to the present invention is a program (a program for causing a computer to operate) that controls a CPU and the like in such a manner as to realize the functions according to the embodiments of the present invention, which are described above. Then, pieces of information that are handled in these devices are temporarily stored in a RAM while being processed. Thereafter, the pieces of information are stored in various ROMs or HDDs, and whenever necessary, are read by the CPU to be modified or written. As a recording medium on which to store the program, among a semiconductor medium (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be used. Furthermore, in some cases, the functions according to the embodiments described above are realized by running the loaded program, and in addition, the functions according to the present invention are realized by performing processing in conjunction with an operating system or other application programs, based on an instruction from the program.

Furthermore, in a case where programs are distributed on the market, the programs, each of which is stored on a portable recording medium, can be distributed, or the program can be transmitted to a server computer that is connected through a network such as the Internet. In this case, a storage device of the server computer is also included in the present invention. Furthermore, some of or all of the portions of the terminal device and the base station device according to the embodiments described above may be realized as an LSI that is a typical integrated circuit. Each functional block of the terminal device and the base station device may be individually realized into a chip, and some of, or all of the functional blocks may be integrated into a chip.

Furthermore, a technique of the integrated circuit is not limited to the LSI, and an integrated circuit for the functional block may be realized with a dedicated circuit or a general-purpose processor. Furthermore, if with advances in a semiconductor technology a circuit integration technology with which an LSI is replaced appears, it is also possible to use an integrated circuit to which such a technology is applied.

The embodiments of the present invention are described in detail above referring to the drawings, but specific configuration is not limited to the embodiments. A design and the like within a scope not departing from the gist of the present disclosure fall within the scope of the claims.

(1) According to an aspect of the present invention, there is provided a wireless communication device that transmits a first wireless signal representing a bit sequence to a reception device, in which the first wireless signal is transmitted concurrently with a second wireless signal representing the bit sequence, and in which, between the first wireless signal and the second wireless signal components with a prescribed ratio are mapped to a different frequency or to a different time between the first wireless signal and the second wireless signal and remaining components are mapped to an identical frequency and to an identical time between the first wireless signal and the second wireless signal.

(2) Furthermore, according to another aspect of the present invention, the wireless communication device according to (1), may further include an interleave module that, in the bit sequence, performs first interleave on bits with a prescribed ratio, and performs second interleave on remaining bits, and a transmission module that generates the first wireless signal from a bit sequence that is output by the interleave module, and transmits the generated first wireless signal in which the second wireless signal may be a wireless signal that is generated from a bit sequence resulted from performing third interleave different from the first interleave on the bits with the prescribed ratio and from a bit sequence resulted from performing the second interleave on the remaining bits.

(3) Furthermore, according to another aspect of the present invention, the wireless communication device according to (1), may further include a DFT module that implements DFT processing on multiple modulation symbols that are based on the bit sequence and generates multiple single carrier symbols, a cyclic shift module that, among the multiple single carrier symbols, performs first cyclic shift that is a shift amount which is 0 or greater in a frequency domain, on single carrier symbols with a prescribed ratio, and performs second cyclic shift that is a shift amount which is 0 or greater in a frequency domain, on remaining single carrier symbols, and a transmission module that generates the first wireless signal from single carrier symbols that are output by the cyclic shift module and outputs the generated first wireless signal, in which the second wireless signal may be a wireless signal that is generated after, among the multiple single carrier symbols, third cyclic shift that is a shift amount which is different from that of the first cyclic shift, is performed on the single carrier symbols with the prescribed ratio and the second cyclic shift is performed on the remaining single carrier symbols.

(4) Furthermore, according to another aspect of the present invention, in the wireless communication device according to any one of (1) to (3), the wireless communication device may generate and transmit the second wireless signal.

(5) Furthermore, according to another aspect of the present invention, in the wireless communication device according to any one of (1) to (3), which transmits the bit sequence to one reception device by cooperating with a different wireless communication device, the second wireless signal may be generated and be transmitted by the different wireless communication device.

(6) Furthermore, according to another aspect of the present invention, in the wireless communication device according to any one of (1) to (5), information indicating the prescribed ratio may be notified by the reception device.

(7) Furthermore, according to another aspect of the present invention, the wireless communication device according to any one of (1) to (5), may further include a ratio determination module that determines the prescribed ratio in such a manner that the reception device is able to demultiplex the first wireless signal and the second wireless signal.

(8) Furthermore, according to another aspect of the present invention, there is provided a wireless communication device including a reception module that receives a signal resulted from spatially multiplexing a first wireless signal and a second wireless signal that represent an identical bit sequence, and a demultiplexing module that demultiplexes the signal received by the reception module into a component of the first wireless signal and a component of the second wireless signal, in which the first wireless signal is transmitted concurrently with the second wireless signal representing the bit sequence, and in which, between the first wireless signal and the second wireless signal, components with a prescribed ratio are mapped to a different frequency or to a different time between the first wireless signal and the second wireless signal and remaining components are mapped to an identical frequency and to an identical time between the first wireless signal and the second wireless signal.

(9) Furthermore, according to another aspect of the present invention, the wireless communication device according to (8), may further include a ratio determination module that determines the prescribed ratio in such a manner that the first wireless signal and the second wireless signal are able to be demultiplexed, and a ratio notification module that notifies the transmission source of the first wireless signal or the second wireless signal of the ratio that is determined by the ratio determination module.

(10) Furthermore, according to another aspect of the present invention, there is provided a wireless communication method including a process of generating a first wireless signal representing a bit sequence, and a process of transmitting the first wireless signal to a reception device, in which the first wireless signal is transmitted concurrently with a second wireless signal representing the bit sequence, and in which between the first wireless signal and the second wireless signal, components with a prescribed ratio are mapped to a different frequency or to a different time between the first wireless signal and the second wireless signal, and remaining components are mapped to an identical frequency and to an identical time between the first wireless signal and the second wireless signal.

(11) Furthermore, according to another aspect of the present invention, there is provided a wireless communication method including a process of receiving a signal resulted from spatially multiplexing a first wireless signal and a second wireless signal that represent an identical bit sequence, and a process of demultiplexing the received signal into a component of the first wireless signal and a component of the second wireless signal, in which the first wireless signal is transmitted concurrently with the second wireless signal representing the bit sequence, and in which, between the first wireless signal and the second wireless signal, components with a prescribed ratio are mapped to a different frequency or to a different time between the first wireless signal and the second wireless signal, and remaining components are mapped to an identical frequency and to an identical time between the first wireless signal and the second wireless signal.

### INDUSTRIAL APPLICABILITY

The present invention is suitably used for a mobile communication system in which a mobile telephone device is set to be a terminal device, but is not limited to this.

### DESCRIPTION OF REFERENCE NUMERALS

10, 10a, 20 WIRELESS COMMUNICATION SYSTEM
100, 200a, 300-1, 300-2 BASE STATION DEVICE
101 CODING MODULE
102 RECEIVE ANTENNA
103 CONTROL INFORMATION RECEPTION MODULE
104 INTERLEAVE SEQUENCE GENERATION MODULE
105-1, 105-M INTERLEAVE MODULE
106 REFERENCE SIGNAL GENERATION MODULE
107-1, 107-M OFDM SIGNAL GENERATION MODULE
108-1, 108-m, 108-M TRANSMIT ANTENNA
111-m MODULATION MODULE
112-m FREQUENCY MAPPING MODULE
113-m IFFT MODULE
114-m CP INSERTION MODULE
115-m WIRELESS TRANSMISSION MODULE
100a, 100b, 200, 400 TERMINAL DEVICE
201-1, 201-N RECEIVE ANTENNA
202-1, 202-n, 202-N OFDM SIGNAL RECEPTION PROCESSING MODULE
203 CHANNEL STATE ESTIMATOR
204 INTERLEAVE CONTROL MODULE
205 CONTROL INFORMATION GENERATION MODULE
206 TRANSMIT ANTENNA
207 REPETITION PROCESSING MODULE
211-n WIRELESS RECEPTION MODULE
212-n CP REMOVAL MODULE
213-n FFT MODULE
214-n FREQUENCY DEMAPPING MODULE
221-1, 221-N CANCELLATION MODULE
222 WEIGHT GENERATION MODULE
223 MIMO DEMULTIPLEXING MODULE
224-1, 224-M LAYER PROCESSING MODULE
225-1 ADDITION MODULE
226-1 DEMODULATION MODULE
227-1 DEINTERLEAVE MODULE
228 COMBINATION MODULE
229 DECODING MODULE
230-1 INTERLEAVE MODULE
231-1 SYMBOL REPLICA GENERATION MODULE
232 REPLICA GENERATION MODULE
233 INTERLEAVE SEQUENCE GENERATION MODULE
301-1, 301-2 CODING MODULE
302-1, 302-2 RECEIVE ANTENNA
303-1, 303-2 CONTROL INFORMATION RECEPTION MODULE
304-1, 304-2 INTERLEAVE SEQUENCE GENERATION MODULE
305-1, 305-2 INTERLEAVE MODULE
306-1, 306-2 REFERENCE SIGNAL GENERATION MODULE
307-1, 307-2 OFDM SIGNAL GENERATION MODULE
308-1, 308-2 TRANSMIT ANTENNA
501-1, 501-M DFT-S-OFDM SIGNAL GENERATION MODULE
502-m DFT MODULE
600-m LAYER PROCESSING MODULE
601-m IDFT MODULE
602-m SYMBOL REPLICA GENERATION MODULE
603-m DFT MODULE
701 CODING MODULE
702 INTERLEAVE MODULE
703 MODULATION MODULE
704 DFT MODULE
705 RECEIVE ANTENNA
706 CONTROL INFORMATION RECEPTION MODULE
707 AMOUNT-OF-CYCLIC-SHIFT DETERMINATION MODULE
708-1, 708-M CYCLIC SHIFT MODULE
709 REFERENCE SIGNAL GENERATION MODULE
710-1, 710-M FREQUENCY MAPPING MODULE
711-1, 711-M IFFT MODULE
712-1, 712-M CP INSERTION MODULE
713-1, 713-M WIRELESS TRANSMISSION MODULE
714-1, 714-M TRANSMIT ANTENNA
801-1, 801-N CANCELLATION MODULE
802 WEIGHT GENERATION MODULE
803 MIMO DEMULTIPLEXING MODULE
804-1, 804-M DE-CYCLIC SHIFT MODULE
805 COMBINATION MODULE
806 ADDITION MODULE
809 DEINTERLEAVE MODULE
810 DECODING MODULE
811 INTERLEAVE MODULE
812 SYMBOL REPLICA GENERATION MODULE
813 DFT MODULE
814-1, 814-M CYCLIC SHIFT MODULE
815 REPLICA GENERATION MODULE
816 AMOUNT-OF-CYCLIC-SHIFT DETERMINATION MODULE

1. A wireless communication device that transmits a first wireless signal representing a bit sequence to a reception device,
wherein the first wireless signal is transmitted concurrently with a second wireless signal representing the bit sequence, and
wherein, between the first wireless signal and the second wireless signal, components with a prescribed ratio are mapped to a different frequency or to a different time between the first wireless signal and the second wireless signal and remaining components are mapped to an identical frequency and to an identical time between the first wireless signal and the second wireless signal.

2. The wireless communication device according to claim 1, further comprising:
an interleave module that, in the bit sequence, performs first interleave on bits with a prescribed ratio, and performs second interleave on remaining bits; and
a transmission module that generates the first wireless signal from a bit sequence that is output by the interleave module, and transmits the generated first wireless signal,
wherein the second wireless signal is a wireless signal that is generated from a bit sequence resulted from performing third interleave different from the first interleave on the bits with the prescribed ratio and from a bit sequence resulted from performing the second interleave on the remaining bits.

3. The wireless communication device according to claim 1, further comprising:
a DFT module that implements DFT processing on multiple modulation symbols that are based on the bit sequence and generates multiple single carrier symbols;
a cyclic shift module that, among the multiple single carrier symbols, performs first cyclic shift that is a shift amount which is 0 or greater in a frequency domain, on single carrier symbols with a prescribed ratio, and performs second cyclic shift that is a shift amount which is 0 or greater in a frequency domain, on remaining single carrier symbols; and
a transmission module that generates the first wireless signal from single carrier symbols that are output by the cyclic shift module and outputs the generated first wireless signal,
wherein the second wireless signal is a wireless signal that is generated after, among the multiple single carrier symbols, third cyclic shift that is a shift amount which is different from that of the first cyclic shift, is performed on the single carrier symbols with the prescribed ratio and the second cyclic shift is performed on the remaining single carrier symbols.

4. The wireless communication device according to claim 1,
wherein the wireless communication device generates and transmits the second wireless signal.

5. The wireless communication device according to claim 1, which transmits the bit sequence to one reception device by cooperating with a different wireless communication device,
wherein the second wireless signal is generated and is transmitted by the different wireless communication device.

6. The wireless communication device according to claim 1,
wherein information indicating the prescribed ratio is notified by the reception device.

7. The wireless communication device according to claim 1, further comprising:
a ratio determination module that determines the prescribed ratio in such a manner that the reception device is able to demultiplex the first wireless signal and the second wireless signal.

8. A wireless communication device that receives a signal resulted from spatially multiplexing a first wireless signal and a second wireless signal that represent an identical bit sequence, the wireless communication device comprising:
a ratio determination module that determines a prescribed ratio in such a manner that the first wireless signal and the second wireless signal are able to be demultiplexed; and
a ratio notification module that notifies a transmission source of the first wireless signal or the second wireless signal of a ratio that is determined by the ratio determination module,
wherein, between the first wireless signal and the second wireless signal, components with the prescribed ratio are mapped to a different frequency or to a different time between the first wireless signal and the second wireless signal, and remaining components are mapped to an identical frequency and to an identical time between the first wireless signal and the second wireless signal.

9. The wireless communication device according to claim 8, further comprising:
a ratio determination module that determines the prescribed ratio in such a manner that the first wireless signal and the second wireless signal are able to be demultiplexed; and
a ratio notification module that notifies the transmission source of the first wireless signal or the second wireless signal of the ratio that is determined by the ratio determination module.

10. A wireless communication method comprising:
a process of generating a first wireless signal representing a bit sequence; and
a process of transmitting the first wireless signal to a reception device,
wherein the first wireless signal is transmitted concurrently with a second wireless signal representing the bit sequence, and
wherein between the first wireless signal and the second wireless signal, components with a prescribed ratio are mapped to a different frequency or to a different time between the first wireless signal and the second wireless signal, and remaining components are mapped to an identical frequency and to an identical time between the first wireless signal and the second wireless signal.

11. (canceled)
